(19) United States
(12) Patent Application Publication
(10) Pub. No.: US 2019/0179671 A1
(43) Pub. Date: Jun. 13, 2019

(54) INFORMATION PROCESSING APPARATUS AND INFORMATION PROCESSING SYSTEM

(71) Applicant: FUJITSU LIMITED, Kawasaki-shi (JP)

(72) Inventor: Naoto Ohnishi, Yokohama (JP)

(73) Assignee: FUJITSU LIMITED, Kawasaki-shi (JP)

(21) Appl. No.: 16/201,298

(22) Filed: Nov. 27, 2018

(30) Foreign Application Priority Data
Dec. 7, 2017 (JP) 2017-234834

(51) Int. Cl. G06F 9/50; G06Q 30/04

(52) U.S. Cl. CPC G06F 9/505; G06Q 30/04

(57) ABSTRACT

An information processing apparatus includes a memory and a processor coupled to the memory. The processor is configured to calculate a surplus resource amount which is an amount of usable unused resources of a computer. The usable unused resources are unused resources usable by one or more users who execute information processing using resources of the computer. The processor is configured to determine an allocated resource amount to be allocated to a first user among the one or more users based on the surplus resource amount and a situation of using the resources by the one or more users.

### CROSS-REFERENCE TO RELATED APPLICATION

This application is based upon and claims the benefit of priority of the prior Japanese Patent Application No. 2017-234834, filed on Dec. 7, 2017, the entire contents of which are incorporated herein by reference.

### FIELD

The embodiments discussed herein are related to an information processing apparatus and an information processing system.

### BACKGROUND

By allocating a predetermined amount of resources to a user before execution of a task based on detection of connection to a virtual machine by the user, a problem of shortage of resources at the time of executing the task is solved. Applications are stably operated by regularly collecting utilization situations of resources, allocating resources necessary for running virtual machines to the virtual machines, and allocating extra resources to the virtual machines according to the priority of the applications. For example, in a cloud system, by proposing to a user a plan with the allocated resource amount that has been reduced based on utilization situations of resources and by allowing the user to select the proposed plan, the idleness of resources increases and the extension of resources addition is suppressed.

Related techniques are disclosed in, for example, Japanese Laid-open Patent Publication Nos. 2014-099036 and 2005-309644, and International Publication Pamphlet No. WO 2017/051474.

### SUMMARY

According to an aspect of the present invention, provided is an information processing apparatus including a memory and a processor coupled to the memory. The processor is configured to calculate a surplus resource amount which is an amount of usable unused resources of a computer. The usable unused resources are unused resources usable by one or more users who execute information processing using resources of the computer. The processor is configured to determine an allocated resource amount to be allocated to a first user among the one or more users based on the surplus resource amount and a situation of using the resources by the one or more users.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating an information processing system according to a first embodiment;

FIG. 2 is a view illustrating an example of an operation of an information processing apparatus illustrated in FIG. 1;

FIG. 3 is a view illustrating an example of an operation flow of the information processing apparatus illustrated in FIG. 1;

FIG. 4 is a view illustrating an information processing system according to a second embodiment;

FIG. 5 is a view illustrating an example of an operation of a management server illustrated in FIG. 4;

FIG. 6 is a view illustrating an example of a fee plan changed by the operation of the management server illustrated in FIG. 5;

FIG. 7 is a view illustrating an example of an operation of collecting resource use rates in a determination period illustrated in FIG. 6;

FIG. 8 is a view illustrating an example of correcting a collected result illustrated in FIG. 7 and summarizing it into a change for each time within the determination period;

FIG. 9 is a view illustrating a first example of an operation of changing allocation of resources of plural users sharing a processing server in the management server illustrated in FIG. 4;

FIG. 10 is a view illustrating a second example of an operation of changing allocation of resources of plural users sharing a processing server in the management server illustrated in FIG. 4;

FIG. 11 is a view illustrating a third example of an operation of changing allocation of resources of plural users sharing a processing server in the management server illustrated in FIG. 4;

FIG. 12 is a view illustrating an example of an operation for independently changing allocation of resources of plural users in the management server illustrated in FIG. 4;

FIG. 13 is a view illustrated an example of an operation flow of the management server illustrated in FIG. 4;

FIG. 14 is a view illustrating an example of a screen displayed on a terminal device operated by a user in steps S30 and S44 illustrated in FIG. 13;

FIG. 15 is a view illustrating an example of an operation of a management server in a third embodiment of the information processing system;

FIG. 16 is a view illustrating an example of a fee plan changed by the operation of the management server illustrated in FIG. 15;

FIG. 17 is a view illustrating an example of an operation flow of the management server that executes the operation illustrated in FIG. 15;

FIG. 18 is a view illustrating an example of a screen on which a user inputs a feeling of use to a terminal device;

FIG. 19 is a view illustrating an example of a screen displayed on a terminal device operated by a user in step S44 illustrated in FIG. 17;

FIG. 20 is a view illustrating an example of an operation of a management server in a fourth embodiment of the information processing system;

FIG. 21 is a view illustrating an example of a fee plan changed by the operation of the management server illustrated in FIG. 20;

FIG. 22 is a view illustrating an example of an operation flow of THE management server that executes the operation illustrated in FIG. 20; and

FIG. 23 is a view illustrating an example of a hardware configuration of the information processing apparatus illustrated in FIG. 1 and the management server illustrated in FIG. 4.

### DESCRIPTION OF EMBODIMENTS

In an information processing system that allocates resources of a computer to a user according to a fee plan selected by the user, when the fee plan is changed, the resources of the computer according to a new fee plan are allocated to the user. The resource amount of the computer to be allocated to the user is predetermined in accordance with the fee plan. Therefore, even when there is a surplus resource in the computer, resources other than the resources corresponding to the fee plan are not allocated to the user and the resources of the computer may not be used effectively.

Hereinafter, embodiments will be described with reference to the drawings.

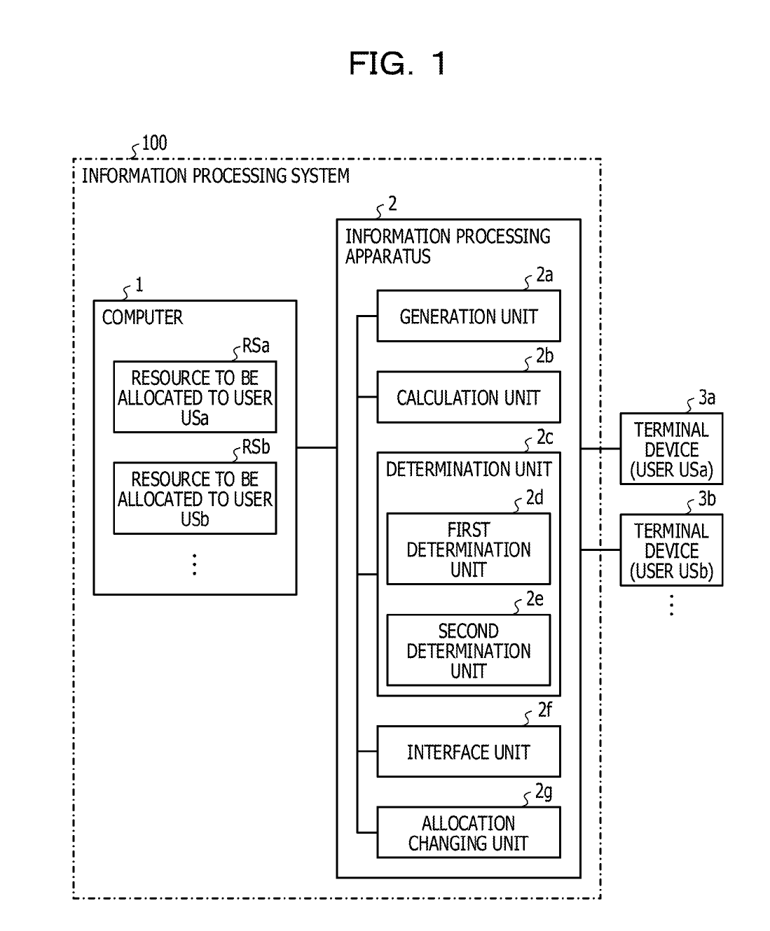

FIG. 1 illustrates an information processing system according to a first embodiment. The information processing system 100 illustrated in FIG. 1 includes a computer 1 such as a server that executes information processing, and an information processing apparatus 2 such as a management server that manages the computer 1. The computer 1 is used to provide services such as a cloud service, and includes various resources, for example, a processor (not illustrated) such as a CPU (Central Processing Unit), a memory such as a main storage device, and a disk device.

The information processing apparatus 2 allocates resources RS (RSa and RSb) of the computer 1 to users US (USa and USb) using the computer 1. Further, the information processing apparatus 2 proposes a fee plan for each user US based on the utilization situations of the resources RS that executes information processing. Terminal devices 3 (3a and 3b) operated respectively by the users US are connected to the information processing device 2 via, for example, a network (not illustrated). The terminal devices 3 cause the resources RS of the computer 1 to execute information processing based on the operation by the users US via the information processing apparatus 2.

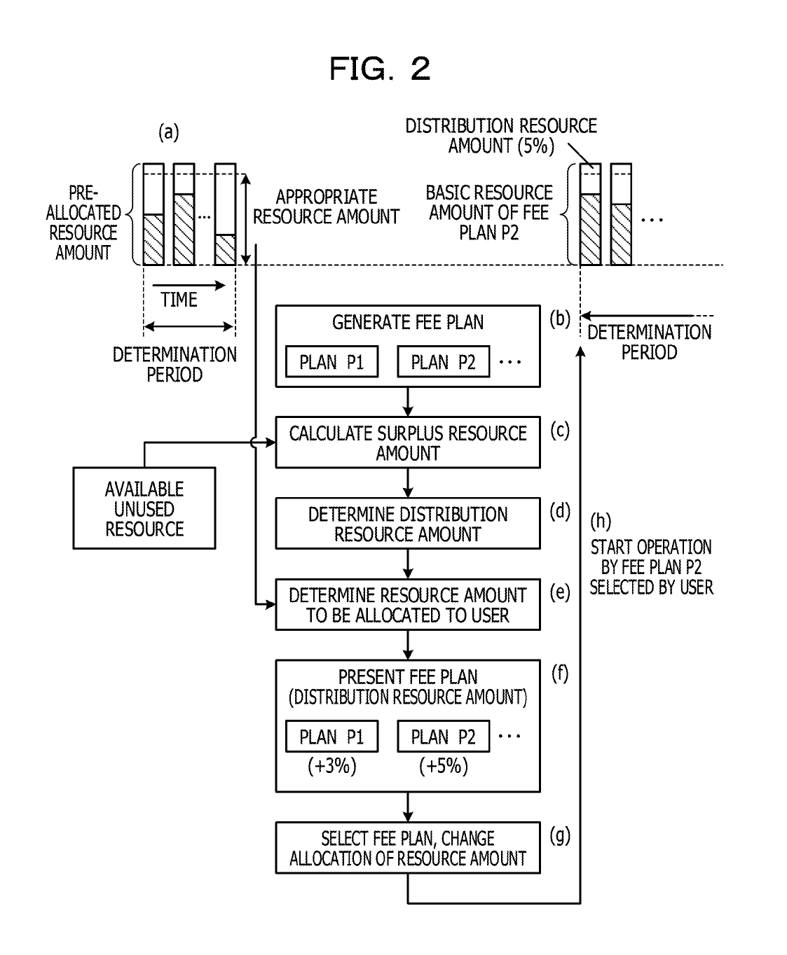

The information processing apparatus 2 includes a generation unit 2a, a calculation unit 2b, a determination unit 2c that includes a first determination unit 2d and a second determination unit 2e, an interface unit 2f and an allocation changing unit 2g. The generation unit 2a, the calculation unit 2b, the determination unit 2c, the interface unit 2f, and the allocation changing unit 2g operate for each user. An example of operations of the generation unit 2a, the calculation unit 2b, the determination unit 2c, the interface unit 2f, and the allocation changing unit 2g will be described with reference to FIG. 2.

For example, the functions of the generation unit 2a, the calculation unit 2b, the determination unit 2c, the interface unit 2f, and the allocation changing unit 2g are implemented by the information processing apparatus 2 that executes a program stored in a memory (not illustrated). The functions of the generation unit 2a, the calculation unit 2b, the determination unit 2c, the interface unit 2f and the allocation changing unit 2g may be implemented by hardware such as FPGA (Field-Programmable Gate Array) included in the information processing apparatus 2.

FIG. 2 illustrates an example of the operation of the information processing apparatus 2 illustrated in FIG. 1. The operation illustrated in FIG. 2 is executed for each resource RS allocated to a user US. In the example illustrated in FIG. 2, a terminal device 3 (FIG. 1) operated by a user US uses a resource RS previously allocated to the computer 1 to cause the computer 1 to execute information processing ((a) of FIG. 2). A thick hatched rectangle indicates the use amount of resources used in information processing, among pre-allocated resource amounts. For example, the thick hatched rectangle indicates the use rate of the pre-allocated resources in a processor, which is one type of resources of the computer 1. The thick hatched rectangle may indicate the use rate (use amount) of a memory of the computer 1 or the use rate (use amount) of a disk device of the computer 1.

In a preset determination period, the generation unit 2a uses the use rate of the resource RS to monitor the use situation of the resource RS and calculates an appropriate resource amount based on the use situation. When the use rate of the resource RS is lower than a preset use rate lower limit, the generation unit 2a sets the use lower limit as the use rate of the resource RS. Then, the generation unit 2a generates new fee plans P1 and P2 corresponding to the appropriate resource amount ((b) of FIG. 2). For example, the fee plan P1 corresponds to an appropriate resource amount and the fee plan P2 corresponds to a resource amount which is larger by a predetermined amount than the appropriate resource amount. The generation unit 2a may generate one fee plan or may generate three or more fee plans.

When the resource amount allocated to the user US has no margin for the use amount of resources used for the information processing, the generation unit 2a generates a fee plan that increases the allocated resource amount to raise the use fee. When the resource amount allocated to the user US has a margin for the use amount of resources used for the information processing, the generation unit 2a generates a fee plan that decreases the allocated resource amount to lower the use fee. FIG. 2 illustrates an example of a case where the resource amount allocated to the user US has a margin for the use amount of d resources used for the information processing.

The calculation unit 2b calculates a surplus resource amount that is a resource amount of an unused resource available to the user US among the resources of the computer 1 ((c) of FIG. 2). When the generation unit 2a generates a fee plan for decreasing the allocated resource amount, the surplus resource amount includes a decrease in the allocated resource amount.

The first determination unit 2d determines a distribution resource amount which is a resource amount allocated to a user US among the surplus resource amount calculated by the calculation unit 2b, for each fee plan generated by the generation unit 2a ((d) of FIG. 2). For example, the distribution resource amount is allocated to the user US at no charge.

The second determination unit 2e determines the sum of the basic resource amount corresponding to the fee plan generated by the generation unit 2a and the distribution resource amount determined by the first determination unit 2d as an allocated resource amount to be allocated to the user US ((e) of FIG. 2). That is, the determination unit 2c determines a new allocated resource amount (including a distribution resource amount) to be allocated to the user US based on the surplus resource amount calculated by the calculation unit 2b and the use situation of resources by the user US. By returning some of unused resources in the computer 1 to the user US, it is possible to effectively use the resources of the computer 1.

The interface unit 2f presents the distribution resource amount (+3%, +5%) determined by the first determination unit 2d to the user US together with the fee plans P1 and P2 generated by the generation unit 2a ((f) of FIG. 2). The presentation to the user US is performed by displaying the fee plans P1 and P2 and the distribution resource amount on the display unit of the terminal device 3. Here, “+3%” indicates that 3% of the basic resource amount is added, and “+5%” indicates that 5% of the basic resource amount is added.

When a resource is a memory or a disk device, the distribution resource amount may be indicated by storage capacity. Then, the interface unit 2f receives information indicating a fee plan selected by the user US (P2 in this example) via the terminal device 3. That is, the interface unit 2f causes the user US to select a fee plan.

The allocation changing unit 2g changes an allocated resource amount available for the user US by allocating the basic resource amount and the distribution resource amount corresponding to the new fee plan P2 selected by the user US to the computer 1 ((g) of FIG. 2). Then, the operation of the resource RS in the new fee plan P2 to which the distribution resource amount (+5%) available at no charge is added is started ((h) of FIG. 2). That is, the user US executes information processing using the resource RS whose allocated resource amount has been changed.

In addition to the basic resources corresponding to the fee plan, the user US can execute the information processing using a resource indicated by the distribution resource amount, thereby further improving the processing performance of the information processing as compared with a case where only the basic resource is used. In the meantime, a service provider that provides a service such as a cloud service using the resources of the computer 1 can strengthen the service to the user US.

Thereafter, the information processing apparatus 2 executes a process of monitoring the use situation of the resource RS in the next determination period, a process of generating a new fee plan, and a process of calculating a surplus resource amount. Further, the information processing apparatus 2 executes a process of determining an allocated resource amount to be allocated to the user US (including a distribution resource amount), and a process of causing the user US to select a fee plan. By changing the distribution resource amount together with the fee plan for each determination period, the user US can use resources of an amount obtained by adding the distribution resource amount to the proper basic resource amount calculated by the generation unit 2a according to the resource use situation. As a result, the user US can cause the computer 1 to execute information processing without feeling a stress such as an increase in processing time due to insufficient processing performance.

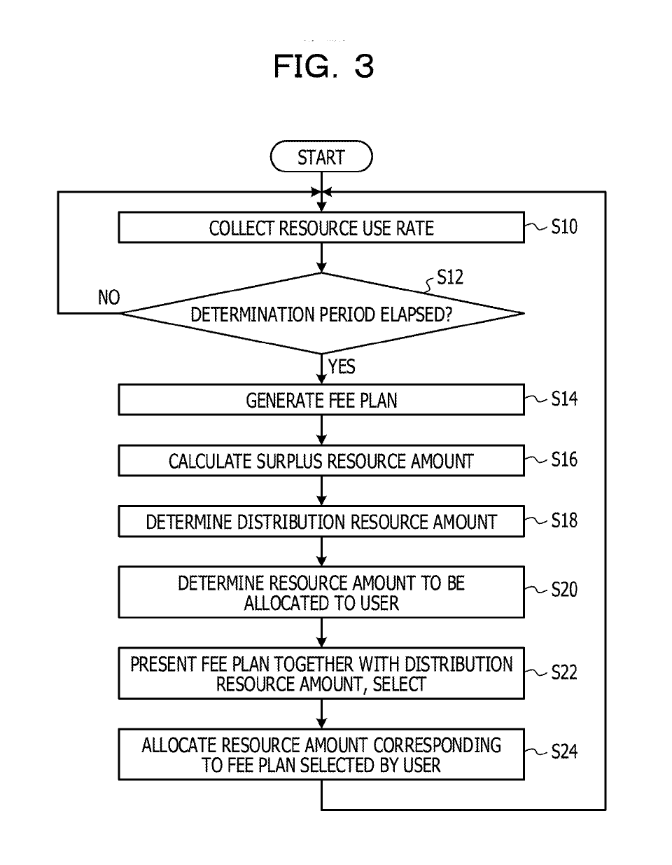

FIG. 3 illustrates an example of an operation flow of the information processing apparatus 2 illustrated in FIG. 1. That is, FIG. 3 illustrates an example of an information processing method by the information processing apparatus 2 and a program executed by the information processing apparatus 2. The operation flow illustrated in FIG. 3 is executed for each resource RS allocated to the user US.

First, in step S10, the information processing apparatus 2 collects the use rates (usage amounts) of resources in the determination period illustrated in FIG. 2. Next, in step S12, when the determination period has elapsed, the information processing apparatus 2 moves the process to step S14. When the determination period has not elapsed, the information processing apparatus 2 returns the process to step S10.

In step S14, the information processing apparatus 2 generates a new fee plan to be proposed to the user US based on the use situation of the resource RS. Next, in step S16, the information processing apparatus 2 calculates an unused surplus resource amount available for the user US among the resources of the computer 1. Next, in step S18, the information processing device 2 determines a distribution resource amount that can be distributed to the user US from the surplus resource amount.

In step S20, the information processing apparatus 2 determines the sum of the basic resource amount corresponding to the fee plan generated in step S14 and the distribution resource amount determined in step S18 as an allocated resource amount to be allocated to the user US. Next, in step S22, the information processing apparatus 2 presents the distribution resource amount determined in step S18 to the user US together with the fee plan generated in step S14 to cause the user US to select a fee plan. Next, in step S24, the information processing apparatus 2 changes the resource amount available for the user US by allocating the allocated resource amount (including the distribution resource amount) corresponding to the fee plan selected by the user US to the computer 1, and returns the process to step S10. That is, the process illustrated in FIG. 3 is repeated for each determination period that is a predetermined period.

As described above, in the first embodiment illustrated in FIGS. 1 to 3, the following effects can be obtained. In the information processing apparatus 2 that allocates the resources of the computer 1 to the user US according to the fee plan selected by the user US, it is possible to return the surplus of the resources to the user US, thereby effectively utilizing the surplus resources not used in the computer 1.

In addition to the basic resources corresponding to the fee plans, the user US can execute the information processing using the resources corresponding to the allocation resource amount which is a portion of the surplus resource amount. As a result, it is possible to further improve the processing performance of information processing to be executed by the computer 1 as compared with the case where only the basic resources are used. Therefore, the user US can cause the computer 1 to execute the information processing without feeling a stress such as an increase in processing time due to insufficient processing performance. A service provider that provides a service such as a cloud service using the resources of the computer 1 can strengthen the service to the user US by returning a portion of the surplus resource amount to the user US.

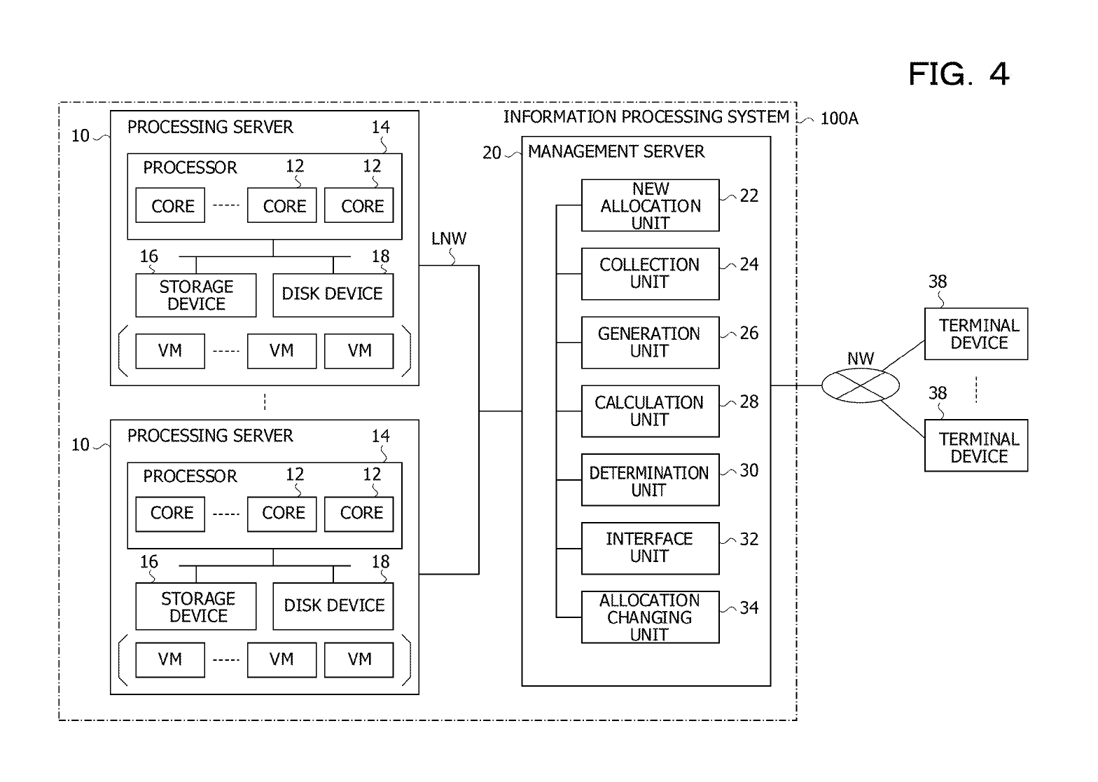

FIG. 4 illustrates an information processing system according to a second embodiment. Detailed description of the same or similar elements as those of the information processing system 100 illustrated in FIG. 1 will be omitted. The information processing system 100A illustrated in FIG. 4 is used, for example, for a service such as a cloud service that provides computer resources via a network NW. Although not particularly limited, IaaS (Infrastructure as a Service) is provided as the cloud service.

The information processing system 100A includes plural processing servers 10 capable of operating plural virtual machines VM for executing information processing, and a management server 20 managing the processing servers 10 to implement a service such as a cloud service. Only one processing server 10 may be used. The processing servers 10 and the management server 20 are interconnected via a network LNW. Each processing server 10 is an example of a computer that executes information processing, and the management server 20 is an example of an information processing apparatus.

Each processing server 10 includes a processor 14 such as a CPU (Central Processing Unit) including plural processor cores 12, a storage device 16 and a disk device 18 connected to the processor 14. The storage device 16 includes, for example, a memory module including plural SDRAM (Synchronous Dynamic Random Access Memory). The disk device 18 includes an HDD (Hard Disk Drive) or an SSD (Solid State Drive). The processing server 10 executes a control program for implementing a virtual machine such as a hypervisor stored in the storage device 16 based on an instruction from the management server 20. By executing the control program, physical resources such as the processor core 12, the storage device 16, and the disk device 18 are divided as virtual resources and operate as virtual machines VM. For example, a virtual resource includes a virtual processor core virtualizing the processor core 12, a virtual storage device virtualizing the storage device 16, and a virtual disk device virtualizing the disk device 18.

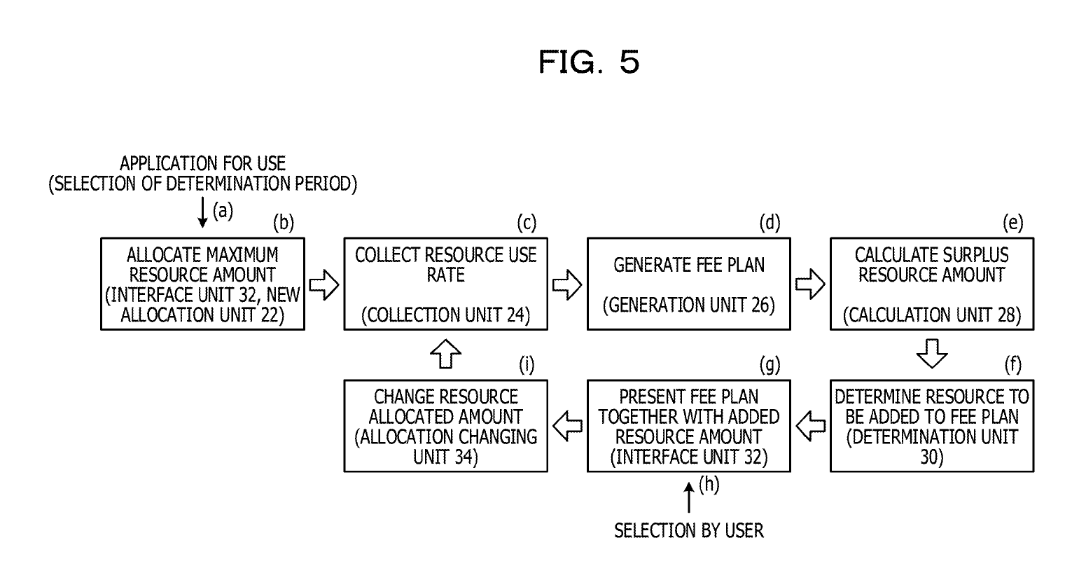

The management server 20 is connected to terminal devices 38 via the network NW such as the Internet or an intranet. The management server 20 includes a new allocation unit 22, a collection unit 24, a generation unit 26, a calculation unit 28, a determination unit 30, an interface unit 32, and an allocation changing unit 34. The functions of the new allocation unit 22, the collection unit 24, the generation unit 26, the calculation unit 28, the determination unit 30, the interface unit 32, and the allocation changing unit 34 will be described with reference to FIG. 5.

The new allocation unit 22, the collection unit 24, the generation unit 26, the calculation unit 28, the determination unit 30, the interface unit 32, and the allocation changing unit 34 are implemented by a processor such as a CPU of the management server 20 executing a program. The new allocation unit 22, the collection unit 24, the generation unit 26, the calculation unit 28, the determination unit 30, the interface unit 32, and the allocation changing unit 34 may be implemented by hardware such as FPGA of the management server 20.

FIG. 5 illustrates an example of an operation of the management server 20 illustrated in FIG. 4. The operation illustrated in FIG. 5 is started for each user on the basis that a user of a virtual machine VM applied for use of a service such as a cloud service.

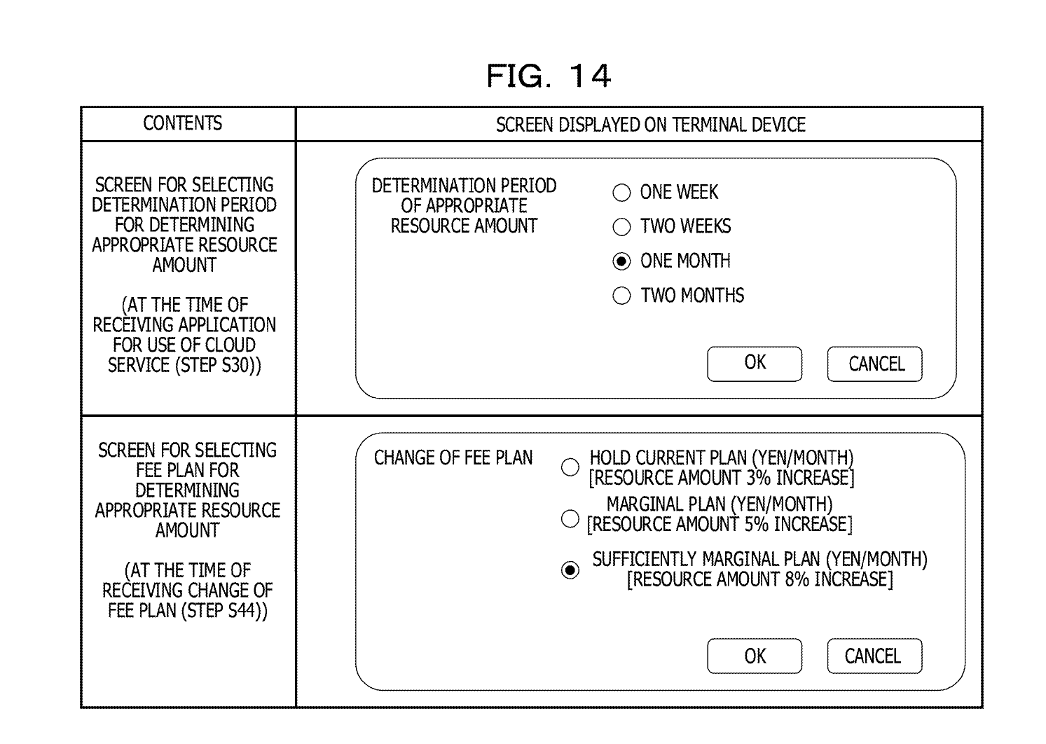

First, the management server 20 receives an application for use of a service from the terminal device 38 operated by the user via the interface unit 32 ((a) of FIG. 5). For example, the interface unit 32 transmits information on a web page that explains the contents of the service based on a request from the terminal device 38. The interface unit 32 receives information indicating that an application button for use in the web page has been pressed by the user's operation, and information on a determination period selected by the user. The determination period corresponds to a cycle for reviewing a fee plan to be described later. An example of a selection period selection screen displayed on the screen of the terminal device 38 is illustrated in FIG. 14.

The new allocation unit 22 allocates a predetermined settable maximum resource amount to a virtual machine VM to be newly operated based on the application for use from a new user using the processing server 10 ((b) of FIG. 5). The maximum resource amount is determined based on the maximum amount of resources of a service provided in the past, for example, and is a resource sufficient for most users who use the service. After a resource is allocated to the virtual machine VM by the new allocation unit 22, the operation of the virtual machine VM is started, and the virtual operation period of the service is started.

By setting an allocated resource amount allocated at the start of service to a value sufficient for most users, the users can omit the calculation of the resource amount necessary for the service (such as the design of deployment of the cloud service, etc.). As a result, the burden on the user at the start of the service can be reduced.

After the service operation by the virtual machine VM is started, the collection unit 24 collects the use rates (use amounts) of various resources in a determination period set by the user ((c) of FIG. 5). For example, the collection unit 24 collects the use rates of the virtual processor cores, virtual storage devices, and virtual disk devices on the virtual machine VM. The collection unit 24 may collect only the use rate of a virtual processor core having the influence on the performance of the virtual machine VM greater than the other virtual processor cores. In the following description, an example will be described in which the use rate of a virtual processor cores is collected and an allocated resource amount of the virtual processor cores is changed.

Based on the use rates of various resources collected by the collection unit 24 during the determination period, the generation unit 26 generates a new fee plan corresponding to the basic resource amount that can operate a service without degrading the performance ((d) of FIG. 5). For example, the generation unit 26 generates plural fee plans having different basic resource amounts.

The calculation unit 28 calculates a surplus resource amount in each of the active virtual machines VM (virtual surplus resource amount) based on the basic resource amount that can be used in the new fee plan generated by the generation unit 26 ((e) of FIG. 5). The virtual surplus resource amount corresponds to a difference between the basic resource amount corresponding to the new fee plan and the allocated resource amount corresponding to the original fee plan, which is calculated by subtracting the basic resource amount corresponding to the new fee plan from the allocated resource amount corresponding to the original fee plan. When the difference in resource amount is negative, the virtual surplus resource amount is set to “0”. The virtual surplus resource amount is an example of a first surplus resource amount.

Further, the calculation unit 28 calculates a resource not used by the virtual machine VM and the hypervisor among the resources of the processing server 10 as a surplus resource amount (physical surplus resource amount). The physical surplus resource amount is an example of a second surplus resource amount. Then, the calculation unit 28 sets the sum of the virtual surplus resource amount and the physical surplus resource amount as a surplus resource amount.

Based on the basic resource amount corresponding to the fee plan generated by the generation unit 26, the determination unit 30 determines a distribution resource amount that is a resource amount that can be distributed to the user of the virtual machine VM among the surplus resource amounts calculated by the calculation unit 28. That is, the determination unit 30 determines a distribution resource amount to be added to the basic resource amount in the new fee plan. Then, the determination unit 30 determines the sum of the basic resource amount corresponding to the fee plan generated by the generation unit 26 and the distribution resource amount as an allocated resource amount to be allocated to the user ((f) of FIG. 5). The determination unit 30 that determines the distribution resource amount is an example of a first determination unit, and the determination unit 30 that determines the sum of the basic resource amount corresponding to the fee plan and the distribution resource amount as an allocated resource amount to be allocated to the user 30 is an example of a second determination unit. Hereinafter, the distribution resource amount is also referred to as an additional resource amount.

The interface unit 32 transmits the information indicating the new fee plan to the terminal device 38 used by the user together with the additional distribution resource amount determined by the determination unit 30 and presents the new fee plan and the additional distribution resource amount on the screen of the terminal device 38 ((g) of FIG. 5). For example, the user uses an input device such as a mouse to select whether to approve the new fee plan presented on the screen ((h) of FIG. 5). When plural fee plans are presented, the user selects one of the plural fee plans. The interface unit 32 receives information indicating the fee plan selected by the user from the terminal device 38 via the network NW.

The allocation changing unit 34 changes the allocated resource amount to the virtual machine VM based on the information indicating the fee plan received by the interface unit 32 from the terminal device 38 ((i) of FIG. 5). That is, the operation of the service in the fee plan selected by the user is started. Thereafter, the collection unit 24 collects the use rate of the resource corresponding to the new fee plan. The collection of use rates of various resources is executed during a determination period. Then, the management server 20 repeatedly performs a process of generating a fee plan, a process of calculating a surplus resource amount, a process of determining an additional distribution resource amount, a process of presenting and selecting a new fee plan, and a process of changing an allocated resource amount.

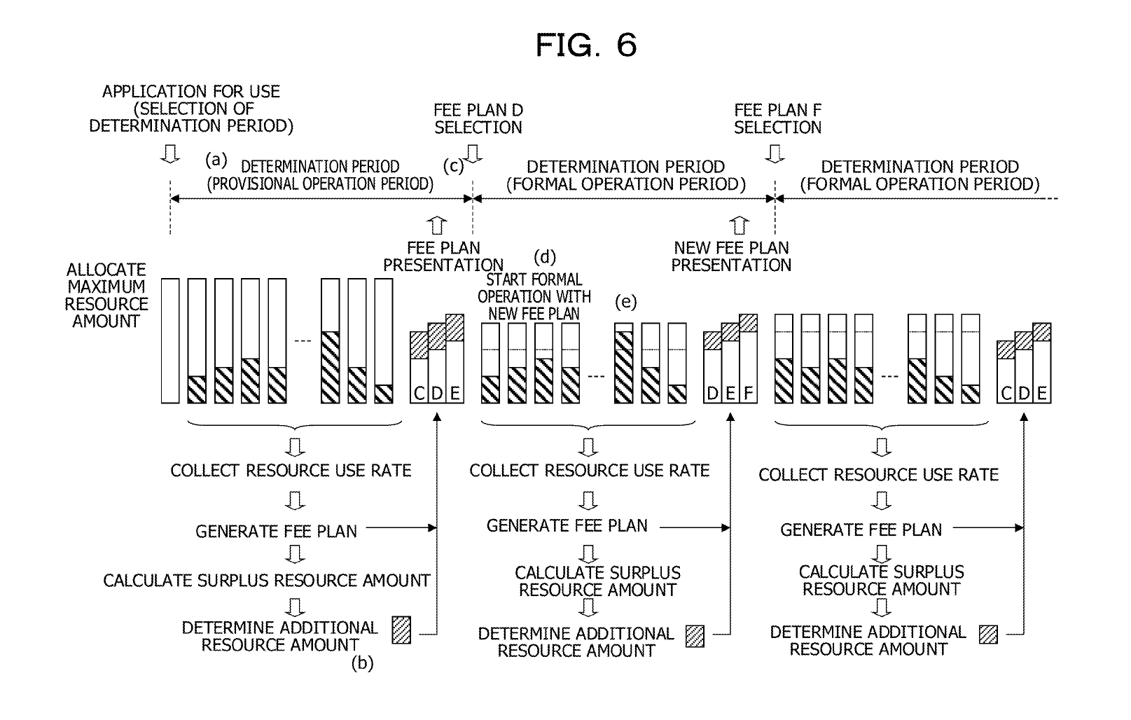

FIG. 6 illustrates an example of a fee plan changed by the operation of the management server 20 illustrated in FIG. 5. Detailed description of the same operation as in FIG. 5 will be omitted. After receiving the application for use of the service including selection of a determination period, the management server 20 allocates the settable maximum resource amount to the virtual machine VM used by the user and starts a provisional operation ((a) of FIG. 6). The provisional operation is the same as the formal operation which is started after selecting the fee plan, except that the maximum resource amount is allocated, and there is no restriction on using the virtual machine VM. Since the determination period is set by selection of a user US, it differs for each user US.

The management server 20 collects the use rates of resources during the determination period of the provisional operation period. Similarly to FIG. 2, the thick hatched rectangle indicates a use resource amount (use rate of a virtual processor core) used in information processing for the allocated resource amount allocated in advance to the virtual machine VM. In the provisional operation period, since the maximum resource amount is allocated to the virtual machine VM, there is almost no possibility that the resource use rate will reach 100%. Thereby, the management server 20 can collect a true use rate which is not limited by the upper limit of the use rate. The management server 20 calculates an appropriate basic resource amount based on the resource use rate collected during the determination period and generates a fee plan corresponding to the appropriate basic resource amount.

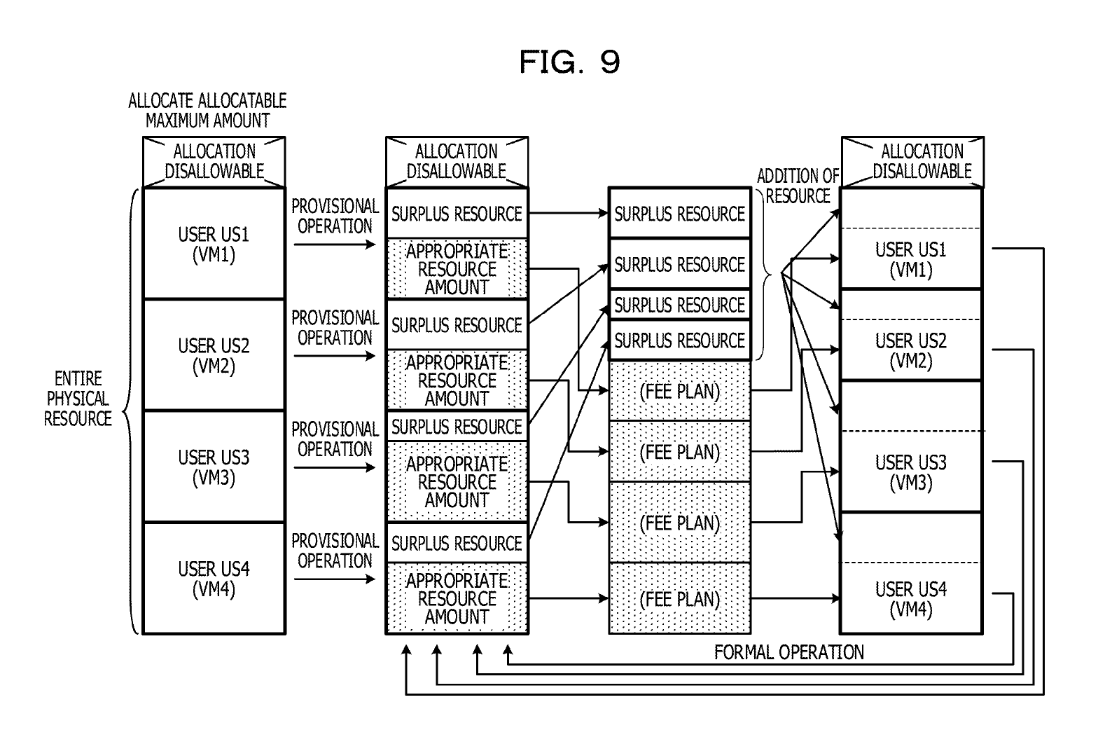

After generating the fee plan, the management server 20 calculates a surplus resource amount (virtual surplus resource amount+physical surplus resource amount). Then, the management server 20 determines an additional resource amount (indicated by a thin hatched rectangle) that can be distributed to the user among the surplus resource amount ((b) of FIG. 6). A method of calculating the additional resource amount will be described with reference to FIGS. 9 to 12.

The management server 20 presents a fee plan together with the additional resource amount to the user, and causes the user to select the fee plan. For example, the user selects a fee plan D ((c) of FIG. 6). In the example illustrated in FIG. 6, the management server 20 presents three fee plans. In the example illustrated in FIG. 6, the additional resource amount is the same irrespective of the fee plan, but it may be different depending on the fee plan. Then, the formal operation in the selected fee plan is started ((d) of FIG. 6).

In addition to the basic resource amount, an additional resource amount is added to the fee plan. Therefore, for example, even when a resource amount corresponding to the use rate of a virtual processor core exceeds the basic resource amount (indicated by a dotted line in the rectangle) corresponding to the fee plan, the processing performance of the information processing by the virtual processor core is not deteriorated ((e) of FIG. 6). The processing performance of the information processing by the virtual processor core is not deteriorated as long as the resource amount corresponding to the use rate of the virtual processor core does not exceed the allocated resource amount allocated to the user (basic resource amount+additional resource amount).

Thereafter, the management server 20 generates a new fee plan based on the use rates of resources collected during the determination period of the provisional operation period, and presents it to the user together with the additional resource amount. Then, the operation of the service is continued by the resource which corresponds to an addition of the basic resource amount corresponding to the fee plan selected by the user and the additional resource amount.

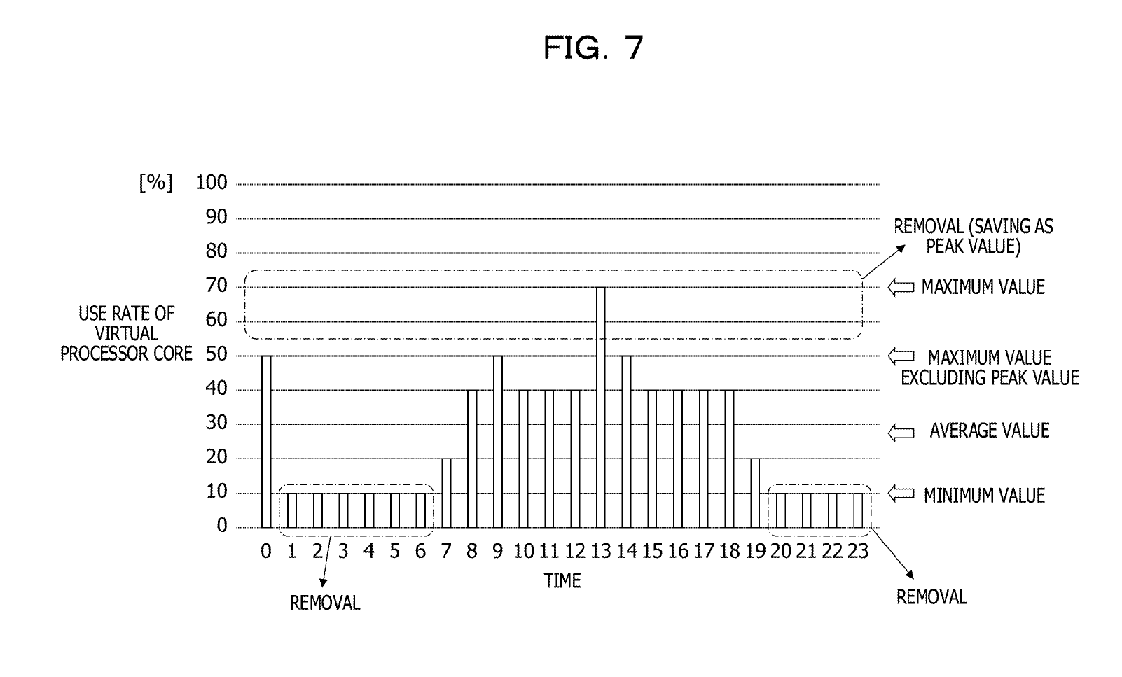

FIG. 7 illustrates an example of an operation of collecting resource use rates in the determination period illustrated in FIG. 6. For example, the collection unit 24 illustrated in FIG. 4 collects the use rates of the virtual processor cores on a daily basis for each time zone during the determination period illustrated in FIG. 6. FIG. 7 illustrates the use rate of a virtual processor core when an allocated resource amount of the virtual processor core allocated to the user is assumed to be 100%. For example, when 50% of the resource amount of one virtual processor core is allocated to the user, the value of ½ of the use rate illustrated in FIG. 7 indicates the use rate of one virtual processor core.

The generation unit 26 illustrated in FIG. 4 detects time zones during which information processing is executed based on a change in use rate for each daily time zone collected by the collection unit 24. Hereinafter, the time zones during which information processing is executed are also referred to as actual operation time zones. For example, the detection of the actual operation time zones may be executed not only daily, but also at predetermined intervals, such as every day of the week or every week.

In the example illustrated in FIG. 7, based on a change in use rate, the generation unit 26 determines that information processing is executed at 0 o'clock zone and from 7 o'clock zone to 19 o'clock zone and no information processing is executed from 1 o'clock zone to 6 o'clock zone and from 20 o'clock zone to 23 o'clock zone. The generation unit 26 generates a fee plan based on the maximum use rate among the use rates excluding the peak portion of the peak value in the actual operation time zones at which information processing is determined to be executed. In other words, the peak portion of the peak value of the use rate and the use rate of time zones other than the actual operation time zones are removed from the information used to generate the fee plan. However, the peak value is stored in the storage device 16 or the disk device 18.

For example, the generation unit 26 generates a fee plan based on a resource amount obtained by adding a predetermined amount of margin to a resource amount corresponding to the maximum value excluding the peak portion of the peak value in the resource use rate. Thereby, it is possible to generate a fee plan that minimizes the burden on users' costs. In the meantime, when a fee plan is generated based on a resource amount corresponding to the peak value, the processing performance of the virtual processor core is not sufficiently used in most of the time zones, which increases the wasteful consumption of resources. In addition, when a fee plan is generated based on a resource amount corresponding to the average value including the peak value and the minimum value which is the use rate of the time zones other than the actual operation time zones, the processing performance of the virtual process core will be insufficient in the actual operation time zones.

As described with reference to FIG. 6, by allocating the settable maximum resource amount to the virtual machine VM, it is possible to substantially eliminate the possibility that the resource use rate in the provisional operation period reaches 100%. Thus, it is possible to prevent the processing performance of information processing using the virtual machine VM from being limited by the upper limit of the use rate. Therefore, the generation unit 26 can propose an optimum fee plan for the user US, which is a fee plan with a predetermined margin in the processing performance. For example, when a resource amount corresponding to 40% illustrated in FIG. 7 is allocated to the virtual machine VM in the provisional operation period, the use rate peaks in all the actual operation time zones, which makes it difficult to generate the optimum fee plan.

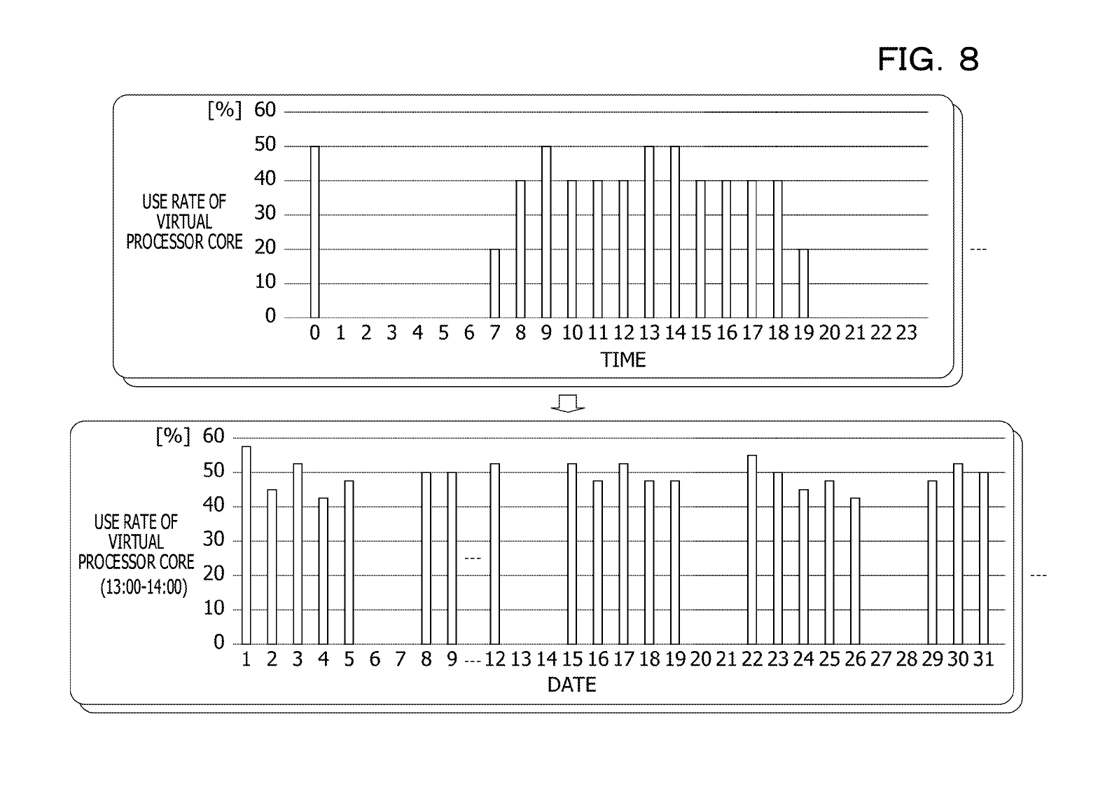

FIG. 8 illustrates an example of an operation of correcting the collected result illustrated in FIG. 7 and summarizing it into a change for each time within the determination period. The upper side of FIG. 8 represents a graph after executing correction to remove the peak portion of the peak value and the minimum value from the collection result illustrated in FIG. 7. As illustrated in the lower side of FIG. 8, the generation unit 26 uses the data obtained by correcting the collected result on each day of the determination period to collect a change in use rate of the virtual processor core for each actual operation time zone in the determination period. The lower graph in FIG. 8 represents a monthly change in use rate of the virtual processor cores at 13 o'clock zone. Then, for example, the generation unit 26 calculates the average value of use rates for each actual operation time zone, and generates a fee plan based on the maximum average value. In addition, the generation unit 26 may detect the maximum value of the use rate and generate a fee plan based on the maximum value.

FIG. 9 illustrates a first example of an operation of changing allocation of resources of plural users sharing the processing server 10 in the management server 20 illustrated in FIG. 4. In the information processing system 100A illustrated in FIG. 4, for example, it is predetermined in advance that up to four virtual machines VM (VM1 to VM4) can be allocated to each processing server 10.

The management server 20 allocates one quarter of allocatable physical resources in the processing server 10 to the virtual machine VM used by the user US based on the application for use of the service from each user US (US1 to US4), and starts a provisional operation. That is, among the entire physical resources of the processing server 10 which starts the provisional operation, physical resources excluding the resources (unallocatable) used by a hypervisor, etc. are equally allocated to the virtual machines VM1 to VM4.

In this manner, the management server 20 allocates a predetermined settable maximum resource amount to a newly operated virtual machine VM. Then, the processing server 10 operates four virtual machines VM (VM1 to VM4) used by the four users US (US1 to US4). In FIG. 9, for ease of explanation, an example where each user US uses one virtual machine VM is illustrated, but one user US may use plural virtual machines VM. The number of virtual machines VM1 allocated to the processing server 10 is not limited to four.

The leftmost side of FIG. 9 illustrates a state in which the virtual machines VM1 to VM4 are allocated and, as a result, there are no free resources. However, it is rare that the virtual machines VM1 to VM4 are allocated at the same time, and usually the virtual machines VM1 to VM4 are sequentially allocated based on a request from the user US. For example, when the virtual machine VM1 is allocated first, resources for allocating the virtual machine VM2 to VM4 are treated as reserved resources but are not treated as surplus resources. Therefore, in FIG. 9, there is no surplus physical resource at the point of time of starting the provisional operation.

After the determination period in the provisional operation for each virtual machine VM has elapsed, the management server 20 calculates an appropriate resource amount (shaded) for each virtual machine VM based on the resource use situation. Here, it is assumed that the appropriate resource amount is the basic resource amount allocated in a fee plan generated later. Then, the management server 20 secures a resource amount obtained by subtracting an appropriate resource amount from the initial allocated maximum resource amount as a surplus resource (that is, a surplus resource amount). That is, a surplus resource is generated from the resources allocated to the virtual machine VM. Further, the management server 20 generates a fee plan corresponding to the calculated appropriate resource amount.

The management server 20 calculates a resource amount (additional resource amount) to be additionally allocated to the virtual machine VM among the secured surplus resource amounts. In the example illustrated in FIG. 9, the additional resource amount is determined according to the ratio of the basic resource amount corresponding to the fee plan set for each virtual machine VM. That is, the additional resource amount is calculated by proportionally dividing the surplus resource amounts according to the basic resource amount corresponding to the fee plan. Then, the operation of the additional resource amount in the new fee plan is started, and a new fee plan is generated after the determination period has elapsed. By proportionally dividing the surplus resource amounts and determining the allocated resource amount to be allocated to each of the plural users US, it is possible to set an appropriate resource amount according to the resource use situation and evenly distribute the surplus resources to the plural users US.

Further, the additional resource amount may be calculated by dividing the surplus resource amount by the number of virtual machines VM. Alternatively, the additional resource amount may be set to a predetermined ratio out of the surplus resource amount. The predetermined ratio is a value smaller than 100%, which may be equal to or less than a ratio evenly distributed to the virtual machines VM (25% in the case of four virtual machines VM).

In this manner, the management server 20 determines an allocated resource amount to be allocated to the user US based on the surplus resource amount and the use situation of the virtual machine VM by the user US. By distributing the surplus resources at a predetermined ratio, even when determining the allocated resource amount to be allocated to each of the plural users US, it is possible to set an appropriate resource amount according to the resource use situation and fairly distribute the surplus resources to the plural users US.

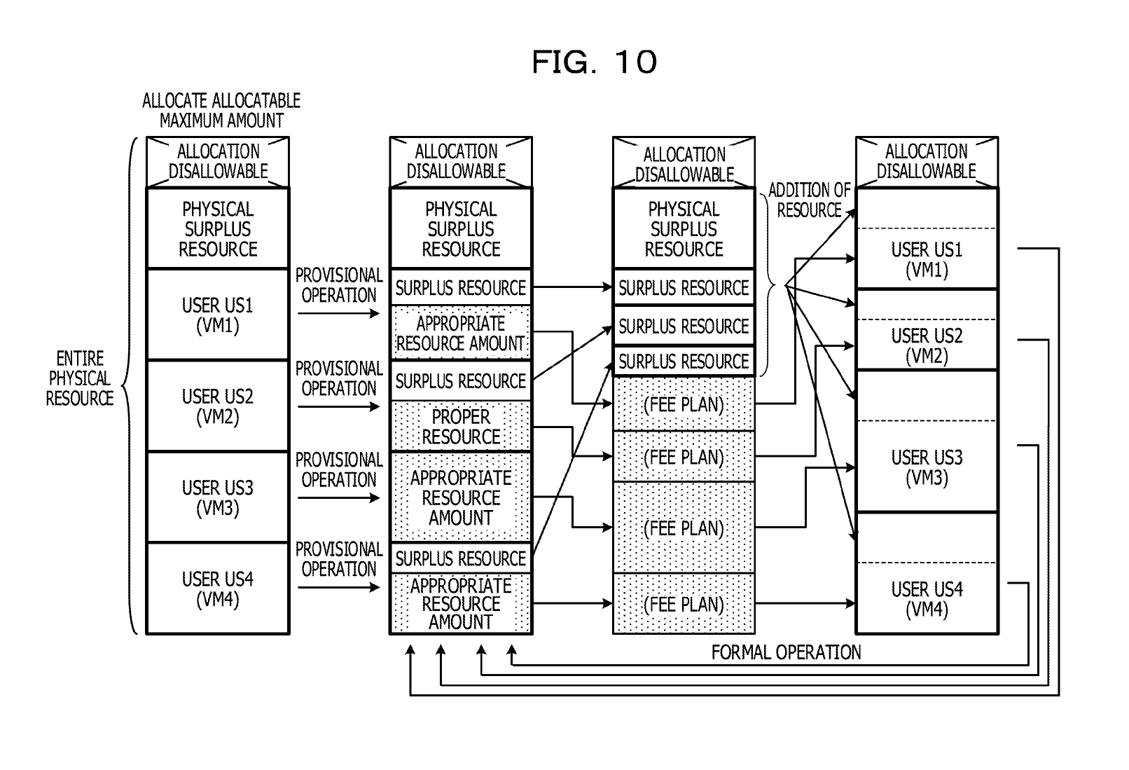

FIG. 10 illustrates a second different example of the operation of changing allocation of resources of the plural users sharing the processing server 10 in the management server 20 illustrated in FIG. 4. Detailed description of the same or similar operation as in FIG. 9 will be omitted.

As in FIG. 9, the management server 20 allocates up to four virtual machines VM1 to VM4 to one processing server 10. However, the management server 20 allocates one quarter of the resources excluding a predetermined amount (physical surplus resource) from the allocatable physical resources in the processing server 10 to the virtual machine VM used by the user US and starts a provisional operation. That is, the management server 20 allocates a predetermined settable maximum resource amount to a newly operated virtual machine VM. The resource amount of a physical surplus resource not used in the processing server 10 is an example of a second surplus resource amount.

After the determination period in the provisional operation has elapsed, the management server 20 calculates an appropriate resource amount for each virtual machine VM based on the resource use situation to secure a surplus resource. In the virtual machine VM3, since the appropriate resource amount is equal to the current resource amount allocated to the virtual machine VM3, no surplus resource is generated. Next, the management server 20 generates a fee plan corresponding to the calculated appropriate resource amount. The resource amount of the surplus resource secured from the resources allocated to the virtual machine VM is an example of a first surplus resource amount which is a difference between the allocated resource amount corresponding to the original fee plan and the basic resource amount corresponding to the new fee plan. Immediately after the end of the provisional operation period, the allocated resource amount corresponding to the original fee plan is the preset allocable maximum resource amount.

Further, the management server 20 calculates a resource amount to be additionally allocated to the virtual machine VM (additional resource amount) from a virtual surplus resource and a physical surplus resource, which are surplus resources secured from the virtual machine VM. In the example illustrated in FIG. 9, the additional resource amount is determined according to the ratio of the basic resource amount corresponding to the fee plan set for each virtual machine VM. That is, the additional resource amount is calculated by proportionally dividing the surplus resource amounts according to the basic resource amount corresponding to the fee plan. Then, the operation in the fee plan including the additional resource amount is started, and a new fee plan is generated after the determination period has elapsed. In this way, not only the virtual surplus resource but also the physical surplus resource can be used to determine the additional resource amount to be additionally allocated to the virtual machine VM.

In the example illustrated in FIG. 10, since the additional resource amount is calculated with the generation of the first fee plan, the physical surplus resource disappears. Therefore, the calculation of the additional resource amount with the generation of the second and subsequent fee plans is executed based on the surplus resource generated in each virtual machine VM as in FIG. 9.

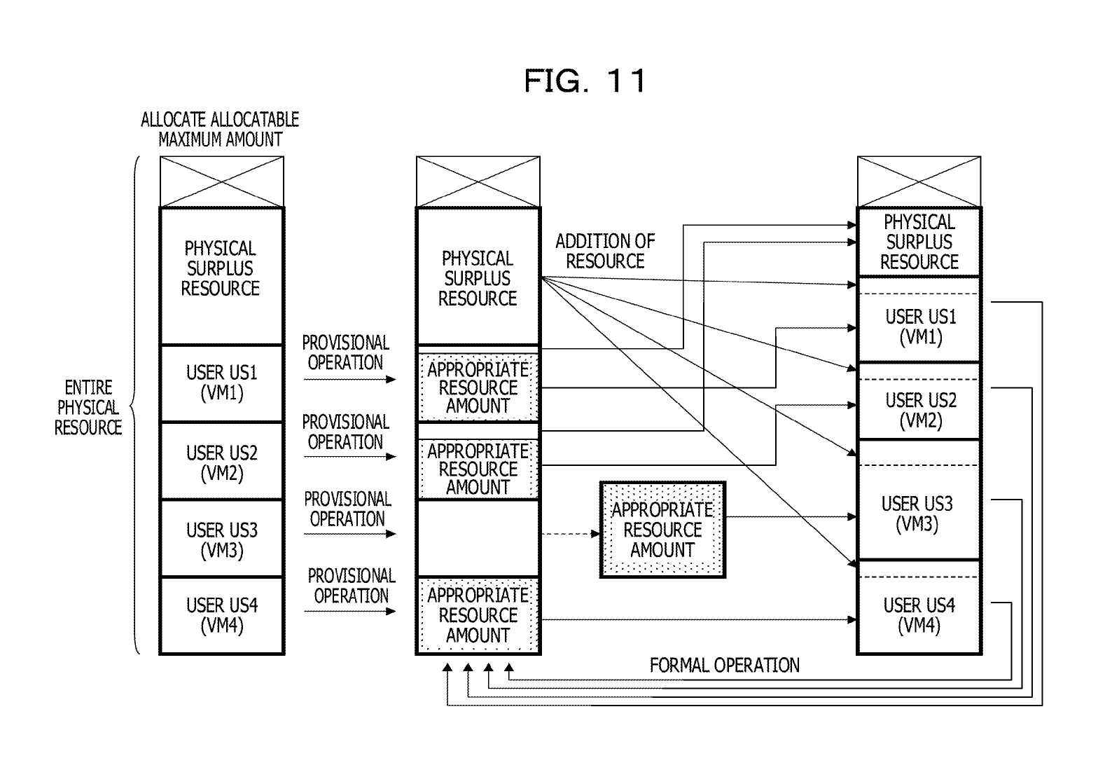

FIG. 11 illustrates a third example of the operation of changing allocation of resources of the plural users sharing the processing server 10 in the management server 20 illustrated in FIG. 4. Detailed description of the same or similar operation as in FIG. 9 will be omitted.

As in FIG. 10, the management server 20 allocates one quarter of the resources excluding a predetermined amount (physical surplus resource) from the allocatable physical resources in the processing server 10 to the virtual machine VM used by the user US, and starts a provisional operation. That is, the management server 20 allocates a predetermined settable maximum resource amount to the newly operated virtual machine VM. The size of the physical surplus resource is larger than the size of the physical surplus resource in FIG. 10.

After the determination period in the provisional operation has elapsed, the management server 20 calculates an appropriate resource amount for each virtual machine VM based on the resource use situation to secure a surplus resource. However, a surplus resource secured from the resources of the virtual machine VM is not used for a resource to be additionally distributed, and is held as a physical surplus resource for additional distribution after the next determination period. Since the appropriate resource amount of the virtual machine VM3 is larger than the current resource amount allocated to the virtual machine VM3, the allocated resource amount is insufficient. The appropriate resource amount of the virtual machine VM4 is equal to the current resource amount allocated to the virtual machine VM4. Therefore, no surplus resources are generated in the virtual machines VM3 and VM4. Next, the management server 20 generates a fee plan corresponding to the calculated appropriate resource amount.

In addition, the management server 20 calculates a resource amount (additional resource amount) to be additionally allocated to the virtual machine VM from the already secured physical surplus resources. That is, in FIG. 11, the additional resource amount is allocated from the physical surplus resource without using the surplus resource of the virtual machine VM. Then, the operation in the fee plan including the additional resource amount is started, a new fee plan is generated after the determination period has elapsed, and the additional resource amount is calculated from the physical surplus resources.

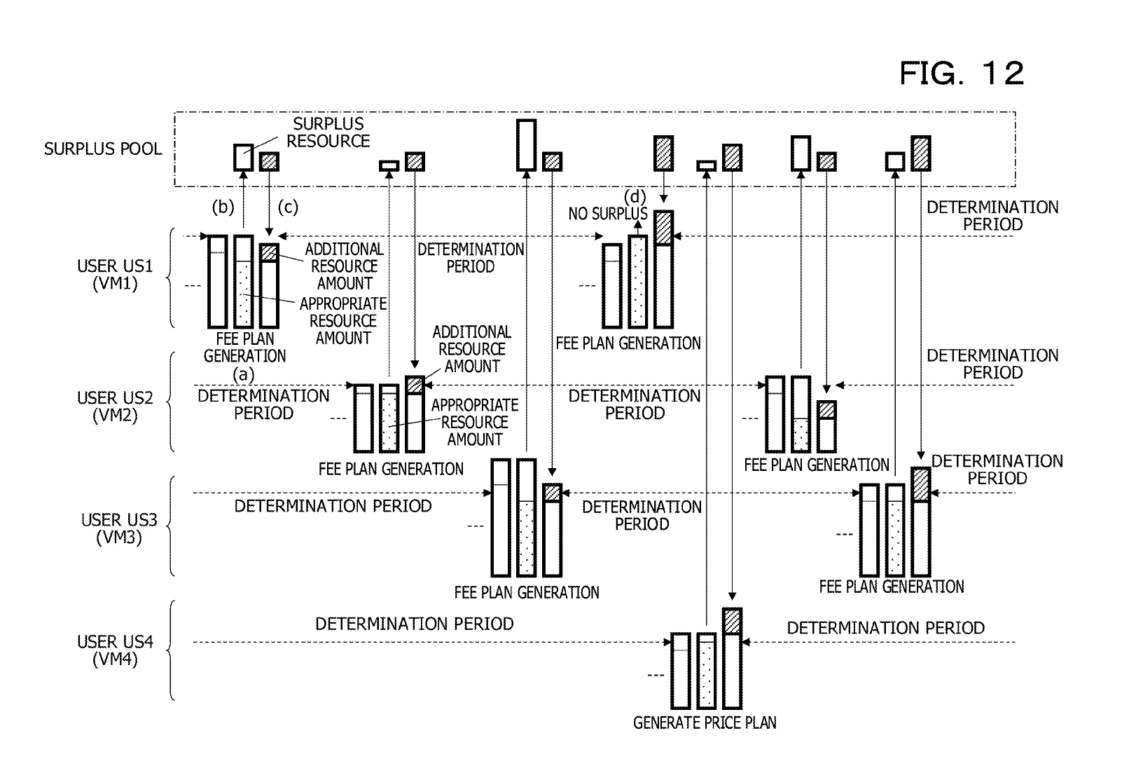

FIG. 12 illustrates an example of an operation for independently changing the allocation of resources of plural users in the management server 20 illustrated in FIG. 4. FIG. 12 illustrates an example of the operation in the formal operation period in FIG. 6. A shaded rectangle indicates an appropriate resource amount as in FIG. 9, and a thin hatched rectangle indicates an additional resource amount distributed to the user US as in FIG. 6.

When the information processing system 100A provides a service such as a cloud service to the user US, the time when the user US applies for use of a service differs for each user US, and the determination period differs for each user U since it is set by the user US. Therefore, the management server 20 generates a new fee plan asynchronously for each user US.

For example, the management server 20 calculates an appropriate resource amount based on the resource use rate of the virtual machine VM1 used by the user US1 and generates a new fee plan ((a) of FIG. 12). When a resource amount difference obtained by subtracting the appropriate resource amount from the allocated resource amount corresponding to the original fee plan has a positive value, the management server 20 secures a resource corresponding to the resource amount difference as a surplus resource in a surplus pool ((b) of FIG. 12).

The surplus pool is not physically provided in the management server 20 but is represented by, for example, a surplus management table which is allocated to the memory of the management server 20 in order to manage the values of the surplus resource amount. The surplus resource secured in the surplus pool includes at least one of a virtual surplus resource that is a surplus resource of the virtual machine VM and a physical surplus resource that is a resource that can be allocated in a resource other than the resource allocated to the virtual machine VM.

The management server 20 calculates an additional resource amount of a resource to be additionally allocated to the virtual machine VM1 based on the surplus resource secured in the surplus pool. The management server 20 adds the calculated additional resource amount to an appropriate resource amount (e.g., the basic resource amount) included in the new fee plan to make a new allocated resource amount ((c) of FIG. 12). After selecting a fee plan by the user US1, the information processing is executed by the virtual machine VM1 whose allocated resource amount has been changed.

Meanwhile, when the resource amount difference obtained by subtracting the appropriate resource amount from the allocated resource amount corresponding to the original fee plan has a negative value, since no surplus resource is generated, the management server 20 does not execute a process of securing a surplus resource in the surplus pool ((d) of FIG. 12). As illustrated in FIG. 12, the management server 20 determines an additional resource amount to be added to the new fee plan based on the surplus resource secured in the surplus pool each time the determination period of the virtual machine VM ends.

As in the explanation in FIG. 9, the management server 20 calculates an additional resource amount that proportionally divides the surplus resource amounts secured in the surplus pool, or calculates an additional resource amount of a ratio that is equal to or less than the ratio that evenly distributes the surplus resource amounts to the virtual machine VM. Thereby, even when the timing of calculating the additional resource amount differs among the virtual machines VM, it is possible to distribute the surplus resources fairly to the plural users US while setting an appropriate resource amount according to the resource use situation.

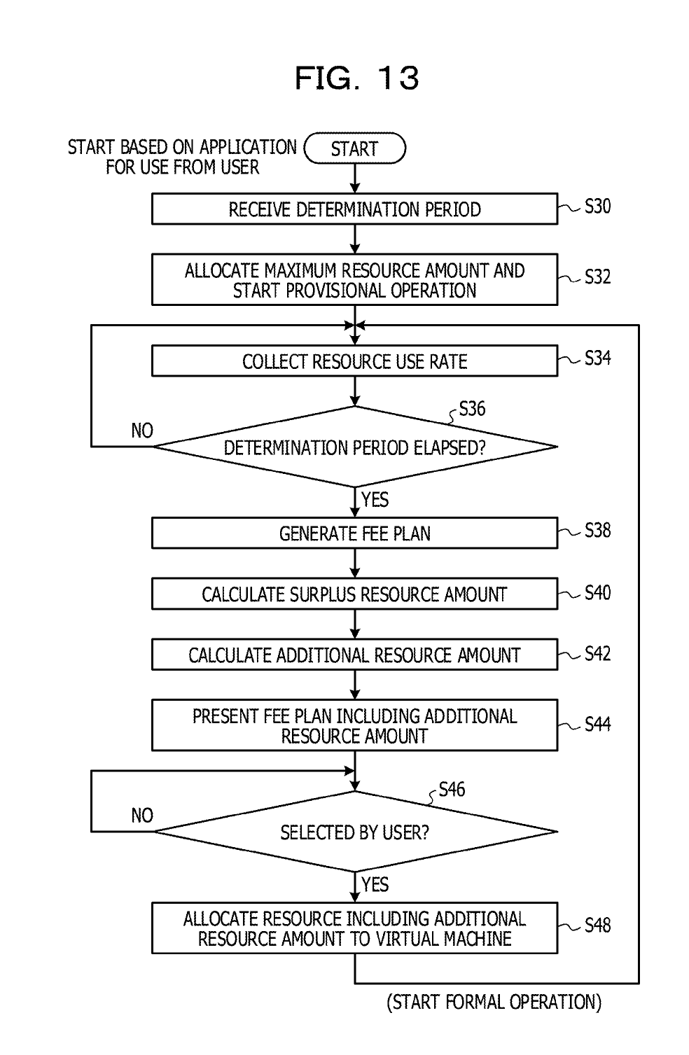

FIG. 13 illustrates an example of an operation flow of the management server 20 illustrated in FIG. 4. That is, FIG. 13 illustrates an example of an information processing method by the management server 20 and a program executed by the management server 20. The operation flow illustrated in FIG. 13 is started for each user US based on the fact that the user US has applied for use of a service such as a cloud service.

First, in step S30, the management server 20 receives a determination period from the user US when applying for use of a service. Next, in step S32, the management server 20 allocates the settable maximum resource amount to the virtual machine VM used by the user US and starts a provisional operation.

Next, in step S34, the management server 20 collects the use rates (use amounts) of the resources allocated to the virtual machine VM used by the user US. Next, in step S36, when the determination period has elapsed, the management server 20 moves the process to step S38. When the determination period has not elapsed, the management server 20 returns the process to step S34.

In step S38, the management server 20 calculates an appropriate resource amount based on the resource use situation and generates a fee plan based on the calculated appropriate resource amount. Next, in step S40, the management server 20 calculates a surplus resource amount which is an unused resource that can be allocated to the virtual machine VM1 in the processing server 10. Next, in step S42, the management server 20 calculates an additional resource amount to be additionally allocated from the surplus resource to the virtual machine VM.

Next, in step S44, the management server 20 presents the fee plan generated in step S14 together with the additional resource amount calculated in step S42 to the user US via the terminal device 38. The additional resource amount is included in the fee plan and is substantially at no charge. The management server 20 may indicate that additional resources to be added free of charge to the fee plan are included without presenting the additional resource amount. Further, the management server 20 may present plural additional resource amounts for each fee plan and cause a user to select one of the plural additional resource amounts.

Next, in step S46, the management server 20 waits until the user US selects a fee plan including the additional resource amount, and moves the process to step S48 based on the selection of the user US. In step S48, the management server 20 allocates a resource including the additional resource amount to the virtual machine VM, and moves the process to step S34 in order to start an operation in a new determination period. That is, the processes from step S34 to step S48 are repeated for each determination period that is a predetermined period.

FIG. 14 illustrates an example of a screen displayed on the terminal device 38 operated by the user US in steps S30 and S44 illustrated in FIG. 13. The management server 20 displays a screen for selecting a determination period for determining an appropriate resource amount on the display unit of the terminal device 38 in step S30 of receiving the application for use of the service. Although not particularly limited, in the present embodiment, the selectable determination period is one week, two weeks, one month or two months.

In addition, in step S44 of receiving a change in fee plan, the management server 20 displays a screen for selecting a fee plan including the additional resource amount on the display unit of the terminal device 38. In FIG. 14, three fee plans are displayed, but the number of fee plans is not limited to three. In addition, a fee plan with a smaller basic resource amount than the current fee plan may be displayed. Furthermore, in a case where a resource to be added to the basic resource corresponding to the fee plan is a memory or a disk device, the additional resource amount may be indicated by an added storage capacity instead of the increase rate. Instead of displaying the amount of resources to be added, it may be displayed that resources are added for free.

As described above, in the second embodiment illustrated in FIGS. 4 to 14, the same effects as those of the first embodiment illustrated in FIGS. 1 to 3 can be obtained. For example, in the management server 20 that allocates the resources of the processing server 10 to the user US according to the fee plan, it is possible to return the surplus of the resources to the user US and effectively utilize the surplus resources not used in the processing server 10. The user US can improve the processing performance of the information processing to be executed by the processing server 10 as compared with a case where only the basic resource corresponding to the fee plan is used. Further, since the surplus resource amount is allocated to the virtual machine VM, the user US can cause the information processing to be executed in the processing server 10 without feeling a stress such as an increase in processing time due to insufficient processing performance.

Furthermore, in the second embodiment illustrated in FIGS. 4 to 14, an allocated resource amount to be allocated to each of the plural users US is determined by apportioning the surplus resources or distributing them at a predetermined ratio. Thereby, it is possible to fairly distribute the surplus resources to the plural users US while setting an appropriate resource amount according to the resource use situation. It is possible to use not only the virtual surplus resource in the virtual machine VM but also the additional resource amount to determine an additional resource amount to be additionally allocated to the virtual machine VM.

By generating a fee plan based on the resource amount corresponding to the maximum value excluding the peak portion of the peak value of the resource use rate, it is possible to generate a fee plan minimizing the cost burden of the user US. By allocating the settable maximum resource amount to the virtual machine VM, the user US can omit the calculation of the resource amount necessary for the service, thereby reducing the burden on the user US at the start of the service. Further, it is possible to prevent the processing performance of information processing using the virtual machine VM from being limited by the upper limit of the use rate.

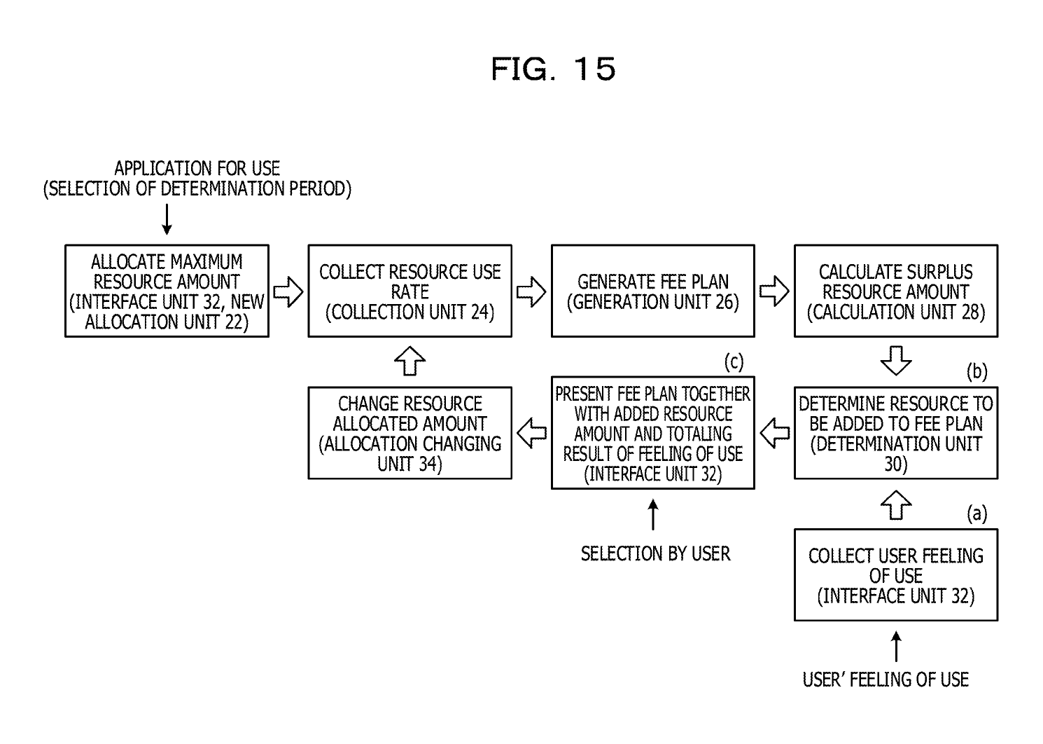

FIG. 15 illustrates an example of an operation of a management server according to a third embodiment of the information processing system. Detailed description of the same or similar operation as in FIG. 5 will be omitted.

As with the management server 20 illustrated in FIG. 4, the management server that executes the operation illustrated in FIG. 15 includes a new allocation unit 22, a collection unit 24, a generation unit 26, a calculation unit 28, a determination unit 30, an interface unit 32 and an allocation changing unit 34. The functions of the new allocation unit 22, the collection unit 24, the generation unit 26, the calculation unit 28 and the allocation changing unit 34 are the same as the functions described in FIG. 5.

The configuration of the information processing system including the management server is the same as that of the information processing system 100A illustrated in FIG. 4, and the information processing system 100A is connected to the terminal device 38 operated by the user via the network NW. Hereinafter, the management server that executes the operation illustrated in FIG. 15 is referred to as a management server 20.

In FIG. 15, a function of collecting from the user the feeling of use of a service such as the service provided by the information processing system 100A is added to the interface unit 32 ((a) of FIG. 15), as compared with FIG. 5.

For example, the feeling of use is collected from an end user directly using a service such as a cloud service. The feeling of use may be collected not only from the end user but also from a user such as a system administrator of a company receiving services.

Further, as compared with FIG. 5, a function of adding an additional resource amount reflecting the collected user's feeling of use to the fee plan is added to the determination unit 30 ((b) of FIG. 15). For example, the determination unit 30 totals use feeling information indicating the user's feeling of use collected by the interface unit 32 and increases the additional resource amount as the satisfaction degree of the result of totaling becomes lower. The function of generating a new fee plan reflecting collected user's feeling of use may be included in the generation unit 26. In this case, the generation unit 26 also has a function of totaling the use feeling information indicating the user's feeling of use collected by the interface unit 32. That is, the determination unit 30 adjusts either the additional resource amount or the basic resource amount corresponding to the new fee plan based on the use feeling information. When presenting a fee plan on the display unit of the terminal device 38, the interface unit 32 has a function of presenting the totaling result of the user's feeling of use together ((c) of FIG. 15).

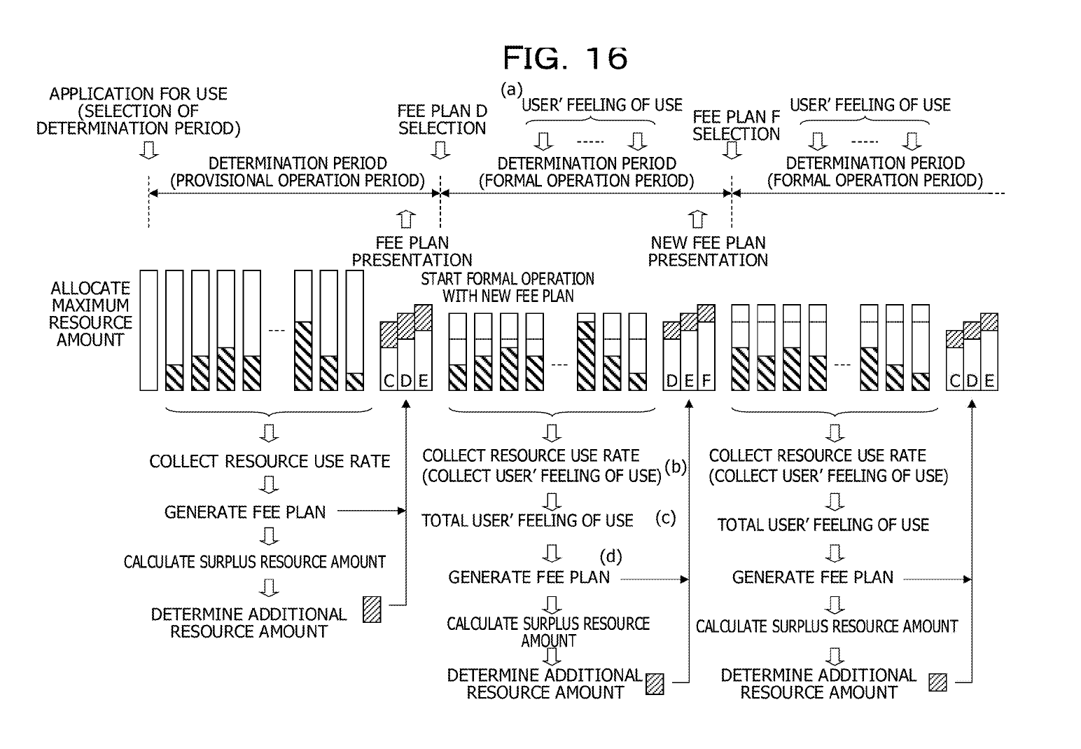

FIG. 16 illustrates an example of a fee plan changed by the operation of the management server illustrated in FIG. 15. Detailed description of the same or similar processing as in FIG. 6 will be omitted. The operation in the provisional operation period is the same as in FIG. 6, and the user's feeling of use is not totaled. This is because the information processing is executed using the maximum resource amount in the provisional operation period, so that the user hardly feels dissatisfied with, for example, the processing performance.

In the formal operation period, the management server 20 can receive the use feeling information indicating the feeling of use from the user ((a) of FIG. 16). Then, the management server 20 collects the use feeling information received from the user via the terminal device 38 ((b) of FIG. 16).

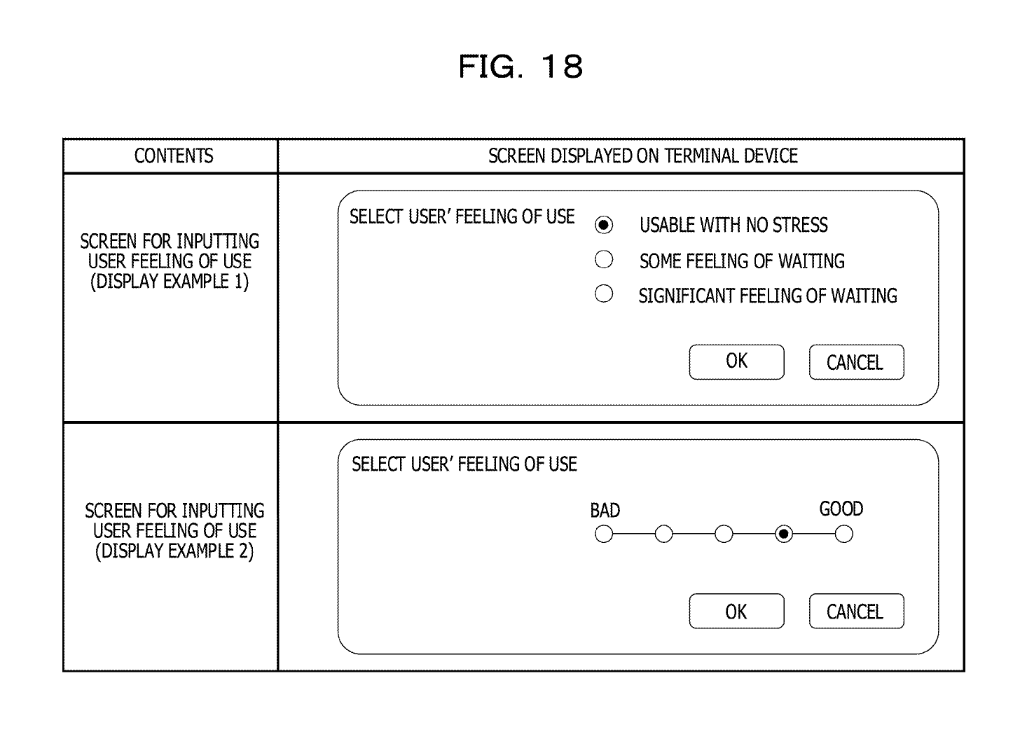

FIG. 18 illustrates a screen displayed on the display unit of the terminal device 38 in order for the user to notify the management server 20 of the feeling of use via the terminal device 38.

The management server 20 totals the collected use feeling information ((c) of FIG. 16). Then, the management server 20 generates a new fee plan corresponding to a resource amount that can operate a service without degrading the performance based on the resource use rate and the totaled use feeling information ((d) of FIG. 16). The subsequent processing is the same as in FIG. 6.

By using the totaled use feeling information at the time of generating the fee plan, it is possible to generate a fee plan that is less prone to a stress to the user than when mathematically generating a fee plan from the resource use rate. As a result, it is possible to increase the satisfaction degree of the user who causes the processing server 10 to execute the information processing as compared with a case where the user's feeling of use is not totaled.

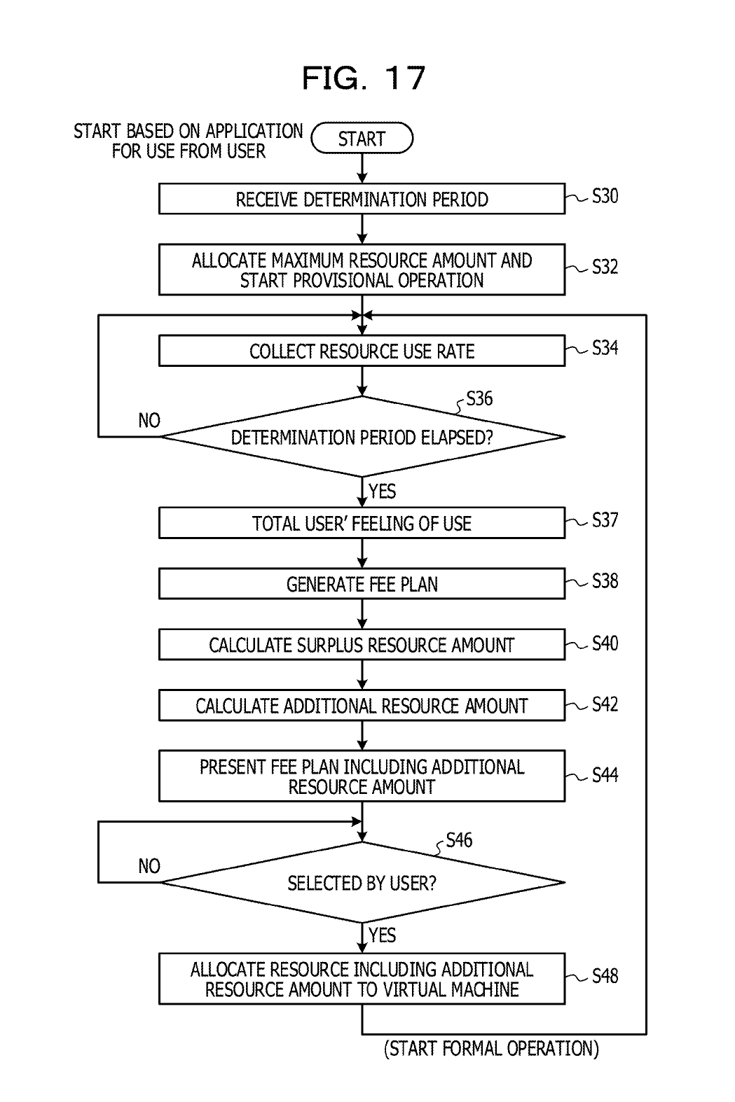

FIG. 17 illustrates an example of an operation flow of the management server 20 that executes the operation illustrated in FIG. 15. That is, FIG. 17 illustrates an example of an information processing method by the management server 20 and a program executed by the management server 20. The same or similar processes as in FIG. 13 are denoted by the same reference numerals and detailed description thereof will not be repeated. FIG. 17 illustrates the same processing as FIG. 13, except that step S37 is inserted between step S36 and step S38 in FIG. 13.

In step S37, the management server 20 totals the use feeling information indicating the user's feeling of use collected during the determination period. Then, in step S38, the management server 20 generates a new fee plan based on the resource use rate and the totaled use feeling information. The management server 20 receives the use feeling information from the terminal device 38 each time the user inputs the feeling of use to the terminal device 38.

Therefore, the process of collecting the user's feeling of use is not illustrated in FIG. 17. Further, as described with reference to FIG. 16, the management server 20 does not collect the use feeling from the user during the determination period of the provisional operation period. Therefore, the processing in step S37 is not included in the operation flow in the provisional determination period.

FIG. 18 illustrates an example of a screen on which the user inputs the feeling of use to the terminal device 38. The screen illustrated in FIG. 18 is displayed by clicking on, for example, a “use feeling input button” displayed on a separate screen before the user inputs the use feeling. The user selects an item closest to the feeling of use of the user. The screen for inputting the feeling of use is not limited to the display example 1 and the display example 2 illustrated in FIG. 18.

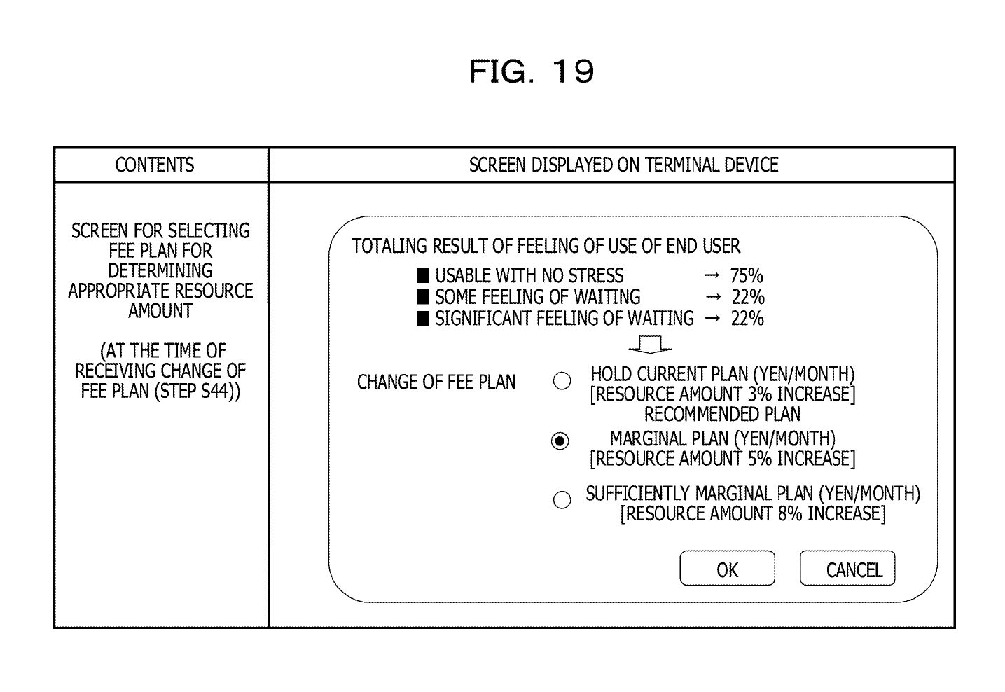

FIG. 19 illustrates an example of a screen displayed on the terminal device 38 operated by the user in step S44 illustrated in FIG. 17. On the screen are displayed the contents indicating the totaling result of the use feeling from the user in addition to the contents that allow selection of a fee plan including the additional resource amount illustrated on the lower side of FIG. 14. Further, as illustrated in FIG. 19, a recommended fee plan may be indicated based on the totaling result of use feeling.

As described above, the third embodiment illustrated in FIGS. 15 to 19 can obtain the same effects as those of the first and second embodiments illustrated in FIGS. 1 to 13. Further, in the third embodiment illustrated in FIGS. 15 to 19, by using the totaled use feeling information at the time of generating the fee plan, it is possible to generate a fee plan that is less prone to a stress to the user than when mathematically generating a fee plan from the resource use rate. As a result, it is possible to increase the satisfaction degree of the user who causes the processing server 10 to execute the information processing as compared with a case where the user's feeling of use is not totaled.

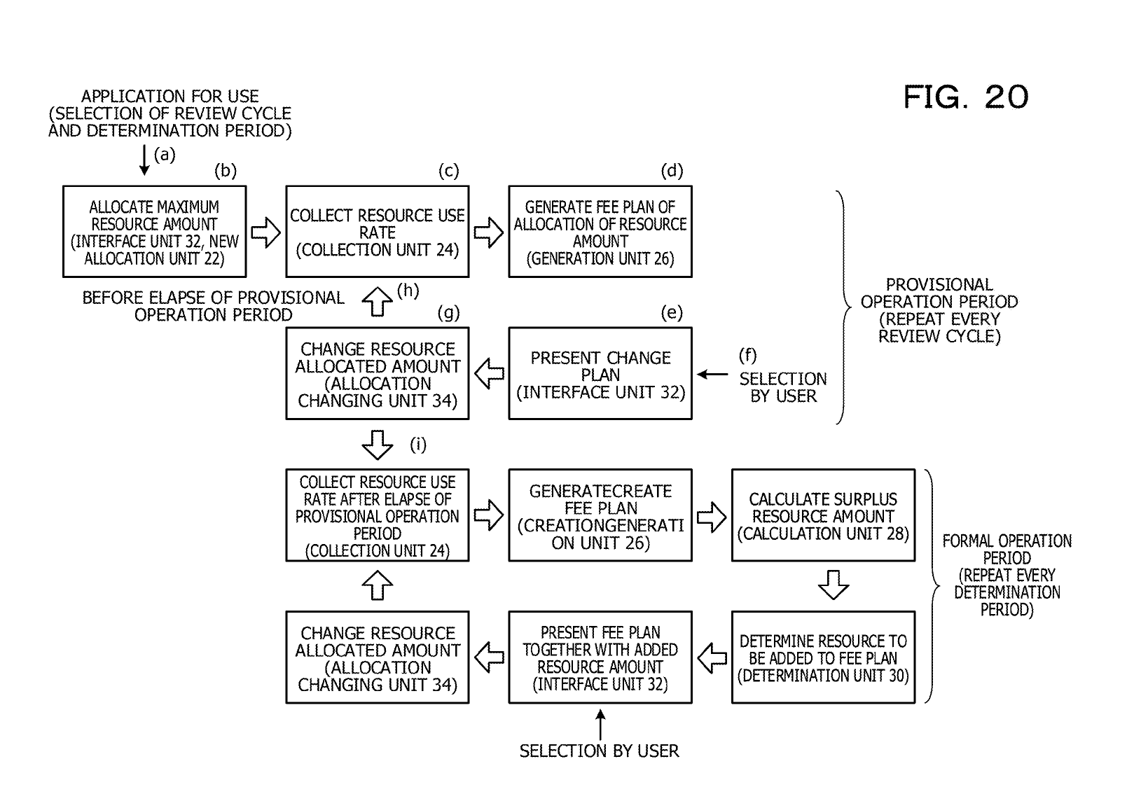

FIG. 20 illustrates an example of an operation of a management server according to a fourth embodiment of the information processing system. Detailed description of the same or similar operation as in FIG. 5 will be omitted.

As with the management server 20 illustrated in FIG. 4, the management server that executes the operation illustrated in FIG. 20 includes a new allocation unit 22, a collection unit 24, a generation unit 26, a calculation unit 28, a determination unit 30, an interface unit 32 and an allocation changing unit 34. The functions of the new allocation unit 22, the collection unit 24, the calculation unit 28, the determination unit 30 and the allocation changing unit 34 are the same as the functions described in FIG. 5.

The configuration of the information processing system including the management server is the same as that of the information processing system 100A illustrated in FIG. 4, and the information processing system 100A is connected to the terminal device 38 operated by the user via the network NW. Hereinafter, the management server that executes the operation illustrated in FIG. 20 is referred to as a management server 20.

In FIG. 20, a function of changing an allocated resource amount during the provisional operation period is added, as compared with FIG. 5. Since the processing in the formal operation period is the same as in FIG. 5, description thereof will not be repeated, and the processing in the provisional operation period will be described below.

First, the management server 20 receives an application for use of a service, including information for selecting a review cycle and a determination period from the terminal device 38 operated by the user via the interface unit 32 ((a) of FIG. 20). The review cycle indicates a cycle of changing an allocated resource amount during the provisional operation period. For example, the review cycle corresponds to a period of about one quarter of the determination period or a period of about one half of the determination period. When the determination period is one month, the review cycle is one week or two weeks. The new allocation unit 22 allocates a predetermined settable maximum resource amount to a newly operated virtual machine VM ((b) of FIG. 20). Then, the operation of the service by the virtual machine VM in the provisional operation period is started.

Next, the collection unit 24 collects use rates (use amounts) of various resources during the period of the review cycle ((c) of FIG. 20). After completion of the review cycle, the generation unit 26 generates a change plan that changes the service to an allocated resource amount that can operate the service without degrading the performance, based on the use rates of various resources collected by the collection unit 24 ((d) of FIG. 20).

Next, the interface unit 32 transmits information indicating the change plan to the terminal device 38 used by the user, and presents the change plan on the screen of the terminal device 38 ((e) of FIG. 20). The user selects whether to approve the change plan presented on the screen ((f) of FIG. 20). When plural change plans are presented, the user selects one of the plural change plans. For example, on the screen for selecting the change plan, “Plan” is displayed instead of “fee plan” on the lower side of FIG. 14, and a fee and an increase rate of resource amount are not displayed.

The allocation changing unit 34 changes the allocated resource amount to the virtual machine VM based on the information of the change plan received by the interface unit 32 from the terminal device 38 ((g) of FIG. 20). That is, the operation of the service in the change plan selected by the user is started. When the provisional operation period does not end, the collection unit 24 executes a process of collecting use rates (use amounts) of various resources in the provisional operation period ((h) of FIG. 20). In the meantime, when the provisional operation period ends, the collection unit 24 executes a process of collecting use rates (use amounts) of various resources in the formal operation period ((i) of FIG. 20). Then, as in FIG. 5, the management server 20 executes a process in the formal operation period.

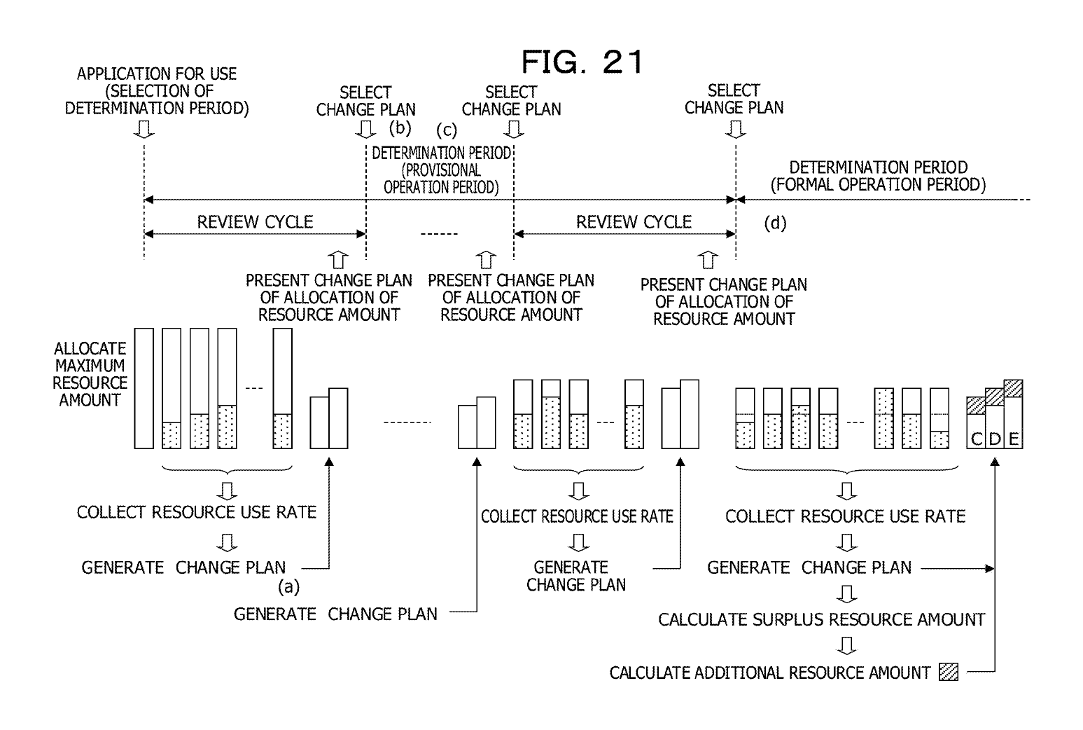

FIG. 21 illustrates an example of a fee plan changed by the operation of the management server 20 illustrated in FIG. 20. Detailed description of the same or similar processing as in FIG. 6 will be omitted. Since the processing in the formal operation period is similar to the processing in the formal operation period illustrated in FIG. 6, description thereof will not be repeated, and the processing in the provisional operation period will be described below.

In the provisional operation period, in each review cycle, a change plan of an allocated resource amount is generated based on the collected resource use rates ((a) of FIG. 21). In the first review cycle, a portion of resources to which the maximum amount is allocated is released as a surplus resource. Then, the allocated resource amount corresponding to the change plan selected by the user is allocated to the virtual machine VM, and the operation in the provisional operation period is continued ((b) and (c) of FIG. 21).

The change of the allocated resource amount is executed for each review cycle during the provisional operation period. When the provisional operation period ends, the operation in the formal operation period is started by the changed allocated resource amount, and a process of generating a fee plan is executed ((d) of FIG. 21). In the formal operation period, as in FIG. 16, the user's feeling of use may be totaled, and a fee plan reflecting the user's feeling of use may be generated.

By reviewing the allocated resource amount plural times based on the use rates of the resources by the user during the provisional operation period, it is possible to release a portion of the resources to which the maximum amount is allocated during the provisional operation period, thereby effectively utilizing the resources of the processing server 10. For example, when the determination period is one month and the review period is one week, a portion of the resources can be released at the point of time when the first week of the provisional operation period has elapsed. In addition, before the official operation period comes, it becomes possible to converge the allocated resource amount allocated to the virtual machine VM to the optimum resource amount.

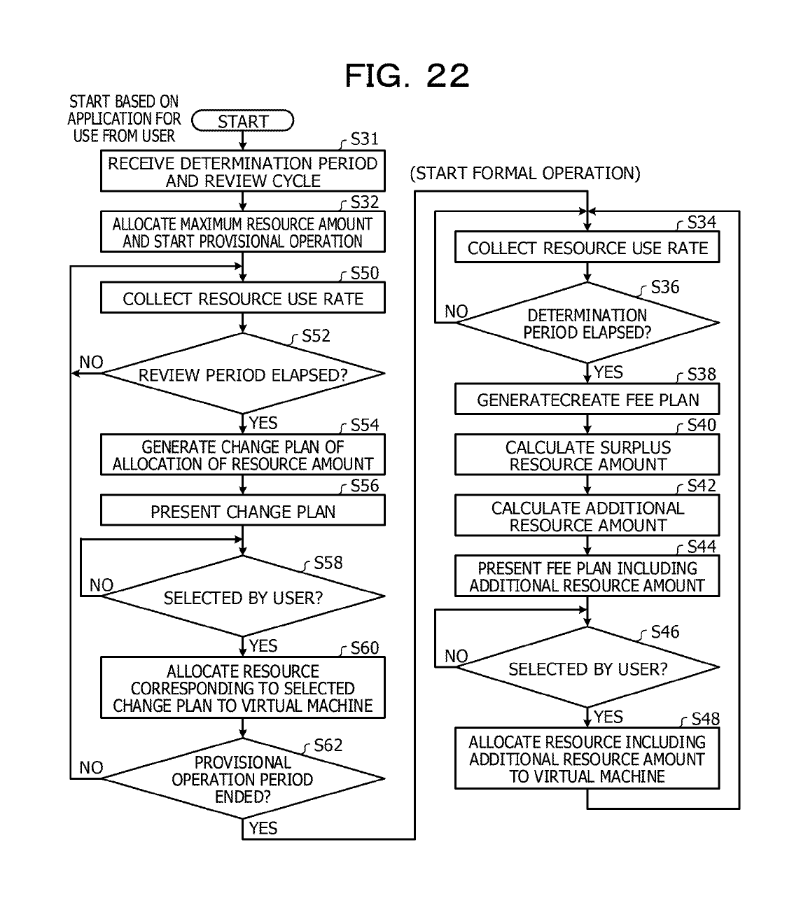

FIG. 22 illustrates an example of an operation flow of the management server 20 that executes the operation illustrated in FIG. 20. That is, FIG. 22 illustrates an example of an information processing method by the management server 20 and a program executed by the management server 20. The same or similar processes as in FIG. 13 are denoted by the same reference numerals, and detailed description thereof will not be repeated. FIG. 22 illustrates the same processing as FIG. 13, except that step S31 is executed instead of step S30 in FIG. 13 and steps S50 to S62 are inserted between step S32 and step S34 in FIG. 13. Further, step S37 of totaling the user's feeling of use illustrated in FIG. 17 may be inserted between step S36 and step S38. In this case, the management server 20 collects the user's feeling of use during the determination period.

In step S31, the management server 20 receives a determination period and a review period from the user US when applying for use of a service. Next, in step S32, the management server 20 allocates a settable maximum resource amount to the virtual machine VM used by the user, and starts a provisional operation.

Next, in step S50, the management server 20 collects the use rates (use amounts) of the resources allocated to the virtual machine VM used by the user. Next, in step S52, when the review period has elapsed, the management server 20 moves the process to step S54. When the review period has not elapsed, the management server 20 returns the process to step S50.

Next, in step S54, the management server 20 calculates an appropriate resource amount for the virtual machine VM based on the resource use situation, and generates a change plan to change the allocated resource amount to the virtual machine VM based on the calculated appropriate resource amount. Next, in step S56, the management server 20 presents the change plan generated in step S54 to the user via the terminal device 38.

Next, in step S58, the management server 20 waits until the user selects the change plan, and moves the process to step S60 based on the selection by the user.

In step S60, the management server 20 allocates a resource corresponding to the change plan selected by the user to the virtual machine VM. Next, in step S62, when the provisional operation period does not end, the management server 20 returns the process to step S50. When the provisional operation period ends, the management server 20 moves the process to step S34 to start the operation in the formal operation period.

As described above, the fourth embodiment illustrated in FIGS. 20 to 22 can obtain the same effects as those of the first, second and third embodiments illustrated in FIGS. 1 to 18. Further, in the fourth embodiment illustrated in FIGS. 20 to 22, by reviewing the allocated resource amount plural times during the provisional operation period, it is possible to release a portion of the resources to which the maximum amount is allocated during the provisional operation period, thereby effectively utilizing the resources of the processing server 10.

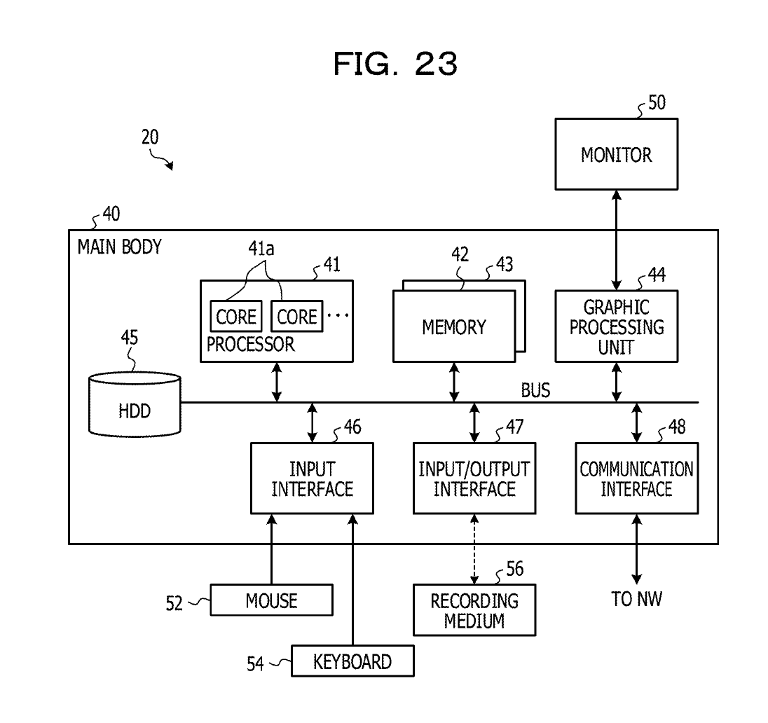

FIG. 23 illustrates an example of a hardware configuration of the information processing apparatus 2 illustrated in FIG. 1 and the management server 20 illustrated in FIG. 4. Since the hardware configurations of the information processing apparatus 2 and the management server 20 are similar to each other, the configuration of the management server 20 will be described below. Note that the computer 1 and the terminal device 3 illustrated in FIG. 1 and the processing server 10 and the terminal device 38 illustrated in FIG. 4 also have the same or similar hardware configurations as those in FIG. 23.

The management server 20 includes a main body 40 such as a mother board, a monitor 50, a mouse 52 and a keyboard 54 connected to the main body 40. The main body 40 includes a processor 41 such as a CPU, memories 42 and 43, a graphic processing unit 44, a HDD (Hard Disk Drive) 45, an input interface 46, an input/output interface 47 and a communication interface 48, which are interconnected via a bus BUS. The main body 40 may have an FPGA.

The processor 41 has plural processor cores 41a that execute arithmetic processing. The main unit 40 may have plural processors 41. Either of the processor cores 41a implements the functions of the information processing apparatus 2 illustrated in FIG. 1 or the management server 20 illustrated in FIG. 4 by executing a program. When the plural processors 41 are provided in the main body 40, one of the plural processors 41 may execute the program.

For example, the memory 42 is a memory module on which plural SDRAMs are mounted, and the memory 43 is a flash memory. The graphic processing unit 44 outputs, for example, image data to be displayed on the monitor 50 to the monitor 50 based on an instruction from the processor 41. The HDD 45 holds, for example, various programs to be executed by the processor 41. The processor 41 executes various programs transferred from the HDD 45 to the memory 42.

The input interface 46 transmits signals received from the input devices such as the mouse 52 and the keyboard 54 to the processor 41. The input/output interface 47 reads information such as various programs or data from a recording medium 56 based on an instruction from the processor 41, and writes the read information in, for example, the HDD 45. Further, the input/output interface 47 reads the information stored in, for example, the HDD 45 based on an instruction from the processor 41, and writes the read information in the recording medium 56. The recording medium 56 is, for example, a CD (Compact Disc)®, a DVD (Digital Versatile Disc)®, or a USB (Universal Serial Bus) memory. The communication interface 48 exchanges information with other devices connected to the network NW via the network NW.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and the processor configured to:
calculate a surplus resource amount which is an amount of usable unused resources of a computer, the usable unused resources being unused resources usable by one or more users who execute information processing by using resources of the computer; and
determine an allocated resource amount to be allocated to a first user among the one or more users based on the surplus resource amount and a situation of using the resources by the one or more users.

2. The information processing apparatus according to claim 1, wherein the processor is further configured to:
generate one or more new fee plans to be proposed to the first user based on a situation of using the resources by the first user;
determine a distribution resource amount that may be allocated to the first user among the surplus resource amount for each of the one or more new fee plans;
determine the allocated resource amount, for each of the one or more new fee plans, by adding the distribution resource amount to a basic resource amount;
present each of the one or more new fee plans to the first user together with the corresponding distribution resource amount to prompt the first user to select one fee plan from among the one or more new fee plans; and
allocate resources corresponding to the allocated resource amount to the first user.

3. The information processing apparatus according to claim 2, wherein the processor is further configured to:
allocate, when the one or more users are plural users, the resources of the computer to each of the plural users; and
determine the distribution resource amount by dividing the surplus resource amount in proportion to the basic resource amount allocated to each of the plural users.

4. The information processing apparatus according to claim 2, wherein the processor is further configured to:
allocate, when the one or more users are plural users, the resources of the computer to each of the plural users; and
determine the distribution resource amount based on a predetermined ratio of the surplus resource amount.

5. The information processing apparatus according to claim 2, wherein the resources allocated to the one or more users are resources to be allocated to a virtual machine that operates on the computer, and
the processor is further configured to:
calculate a first surplus resource amount for each of the one or more new fee plans, the first surplus resource amount being a difference between the allocated resource amount corresponding to the current fee plan and the basic resource amount corresponding to a relevant new fee plan;
calculate a second surplus resource amount which is an amount of resources not used in the computer; and
determine the distribution resource amount based on the first surplus resource amount and the second surplus resource amount.

6. The information processing apparatus according to claim 2, wherein the processor is further configured to:
collect information regarding a use rate of a processor of the computer for each of predetermined time zones, the use rate being one type of resources of the computer;
detect, based on a change in the use rate, time zones during which the information processing is executed; and
generate the one or more new fee plans based on a maximum use rate among use rates excluding at least one peak value in the detected time zones.

7. The information processing apparatus according to claim 2, wherein the processor is further configured to:
execute, for each of predetermined periods set by the first user, the generation of the one or more new fee plans, the calculation of the surplus resource amount, the determination of the distribution resource amount, the determination of the allocated resource amount, the presentation of the one or more new fee plans, and the allocation of the resources.

8. The information processing apparatus according to claim 2, wherein the processor is further configured to:
receive use feeling information from a terminal device operated by the first user, the use feeling information indicating feeling of use of the computer by the first user; and
adjust the distribution resource amount or the basic resource amount corresponding to each of the one or more new fee plans based on the use feeling information.

9. The information processing apparatus according to claim 1, wherein the processor is further configured to:
allocate a maximum amount of allocatable resources to a new user who uses the resources of the computer, the maximum amount of allocatable resources being set in advance.

10. An information processing system comprising:
a computer including resources to be used by one or more users to execute information processing, the resources including a first memory and a first processor coupled to the first memory; and
an information processing apparatus including:
a second memory; and
a second processor coupled to the second memory and the second processor configured to:
calculate a surplus resource amount which is an amount of usable unused resources of the computer, the usable unused resources being unused resources usable by the one or more users; and
determine an allocated resource amount to be allocated to a first user among the one or more users based on the surplus resource amount and a situation of using the resources by the one or more users.

11. A non-transitory computer-readable recording medium having stored therein a program that causes a first computer to execute a process, the process comprising:
calculating a surplus resource amount which is an amount of usable unused resources of a second computer, the usable unused resources being unused resources usable by one or more users who execute information processing by using resources of the second computer; and
determining an allocated resource amount to be allocated to a first user among the one or more users based on the surplus resource amount and a situation of using the resources by the one or more users.
